(19) United States
(12) Patent Application Publication
(10) Pub. No.: US 2025/0171950 A1
(43) Pub. Date: May 29, 2025

(54) CLOTHES CARE APPARATUS AND METHOD FOR CONTROLLING THE SAME

(71) Applicant: Samsung Electronics Co., Ltd., Suwon-si (KR)

(72) Inventors: Gimun GWAK, Suwon-si (KR); Sujin SEONG, Suwon-si (KR); Hyunjun CHUNG, Suwon-si (KR); Yeona HWANG, Suwon-si (KR); Youngchul KO, Suwon-si (KR); Jungha PARK, Suwon-si (KR); Kisup LEE, Suwon-si (KR)

(21) Appl. No.: 18/947,342

(22) Filed: Nov. 14, 2024

Related U.S. Application Data
(63) Continuation of application No. PCT/KR2024/015608, filed on Oct. 15, 2024.

(30) Foreign Application Priority Data
Nov. 24, 2023 (KR) 10-2023-0166131

(51) Int. Cl. D06F 73/02; C02F 1/461; D06F 58/20

(52) U.S. Cl. CPC D06F 73/02; C02F 1/46104; D06F 58/203; C02F 2307/12

(57) ABSTRACT

A clothes care apparatus may include: a main body; a chamber formed in the main body; a heat exchanger configured to dehumidify air in the chamber; a water purification filter; a water tank disposed downstream of the water purification filter; a steam generation device comprising a steam generator including a case and configured to generate steam using water supplied from the water tank and spray the generated steam into the chamber; a sump configured to store at least one of condensate discharged from the heat exchanger or condensate discharged from the steam generation device; a water supply pump configured to pump water stored in the water tank to the steam generation device; a sump pump configured to pump water stored in the sump to the water purification filter; a circulation pump configured to pump water in the steam generation device to the sump or the water purification filter; and a controller comprising at least one processor, comprising processing circuitry, individually and/or collectively, configured to operate the circulation pump based on a specified condition being satisfied.

### CROSS-REFERENCE TO RELATED APPLICATIONS

This application is a continuation of International Application No. PCT/KR2024/015608 designating the United States, filed on Oct. 15, 2024, in the Korean Intellectual Property Receiving Office and claiming priority to Korean Patent Application No. 10-2023-0166131, filed on Nov. 24, 2023, in the Korean Intellectual Property Office, the disclosures of each of which are incorporated by reference herein in their entireties.

### BACKGROUND

### Field

The disclosure relates to a clothes care apparatus including a steam generation system that may reuse contaminated water and a method for controlling the clothes care apparatus.

### Description of Related Art

A clothes care apparatus is a device that performs clothes care, such as drying wet clothes, removing dirt or odor from clothes, and reducing wrinkles in clothes.

The clothes care apparatus may include a heat exchanger for dehumidifying and heating air in a care room for drying clothes, and a steam generation device for performing refreshing functions such as removing wrinkles in clothes, deodorizing clothes, removing static electricity from clothes, providing fragrance, and the like.

The clothes care apparatus includes a water tank for storing water supplied to the steam generation device, and a drain tank for storing water discharged from the steam generation device or heat exchanger.

Users are required to periodically fill the water tank with water and empty the drain tank in order to use the clothes care apparatus.

### SUMMARY

Embodiments of the disclosure provide a clothes care apparatus wherein, a user is not required to fill a water tank and empty a drain tank, thereby improving user convenience.

Embodiments of the disclosure provide a clothes care apparatus wherein, an integrated water tank that functions as both a water tank and a drain tank may be provided, thereby improving ease of maintenance.

Embodiments of the disclosure provide a clothes care apparatus wherein, water stored in a steam generation device may be periodically filtered, and thus clean steam may be sprayed into a chamber.

Embodiments of the disclosure provide a clothes care apparatus wherein, water stored in a steam generation device may pass through a water purification filter only when the water needs to be treated, thereby improving a life of the water purification filter.

Embodiments of the disclosure provide a clothes care apparatus wherein, water stored in a steam generation device may selectively pass through a filter according to a state of the water, thereby improving a life of the filter.

The effects that may achieved by the disclosure are not limited to the above-mentioned effects, and other effects not mentioned will be clearly understood by one of ordinary skill in the technical art to which the disclosure belongs from the following description.

According to an example embodiment of the disclosure, a clothes care apparatus may include: a main body; a chamber formed in the main body; a heat exchanger configured to dehumidify air in the chamber; a water purification filter; a water tank disposed downstream of the water purification filter; a steam generation device including a steam generator including a case and configured to generate steam using water supplied from the water tank and spray the generated steam into the chamber; a sump configured to store at least one of condensate discharged from the heat exchanger or condensate discharged from the steam generation device; a water supply pump configured to pump water stored in the water tank to the steam generation device; a sump pump configured to pump water stored in the sump to the water purification filter; a circulation pump configured to pump water in the steam generation device to the sump or the water purification filter; and a controller comprising at least one processor, comprising processing circuitry, individually and/or collectively, configured to operate the circulation pump based on a specified condition being satisfied.

According to an example embodiment of the disclosure, a method for controlling a clothes care apparatus including a water purification filter, a water tank disposed downstream of the water purification filter, a steam generation device including a steam generator comprising a case and configured to generate steam using water supplied from the water tank and spray the generated steam to a chamber, and a sump configured to store at least one of condensate discharged from a heat exchanger configured to dehumidify air in the chamber or condensate discharged from the steam generation device, the method including: pumping water in the steam generation device to the sump or the water purification filter, based on a specified condition being satisfied.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating an example clothes care apparatus according to various embodiments;

FIG. 2 is a perspective view illustrating an example clothes care apparatus with an open door according to various embodiments;

FIG. 3 is a side cross-sectional view of a clothes care apparatus according to various embodiments;

FIG. 4 is an exploded perspective view of a clothes care apparatus according to various embodiments;

FIG. 5 is a partial sectional perspective view illustrating a portion in which a steam ejector of a steam generation device of a clothes care apparatus is disposed according to various embodiments

FIG. 6 is a diagram illustrating an enlarged view of a portion A of FIG. 3 according to various embodiments;

FIG. 7 is a perspective view of a steam generator of a steam generation device of a clothes care apparatus according to various embodiments;

FIG. 8 is a perspective view of the steam generation device taken along line A-A′ of FIG. 7 according to various embodiments;

FIG. 9 is a side cross-sectional view of a steam generator of a steam generation device of a clothes care apparatus according to various embodiments;

FIG. 10 is a front cross-sectional view of a steam generator of a steam generation device of a clothes care apparatus according to various embodiments;

FIG. 11 includes perspective views illustrating an example of an electrode sensor for detecting water level in a steam generation device of a clothes care apparatus according to various embodiments;

FIG. 12 is a block diagram illustrating an example configuration of a clothes care apparatus according to various embodiments;

FIG. 13 is a diagram illustrating an example of a steam generation system according to various embodiments;

FIG. 14 is a diagram illustrating another example of a steam generation system according to various embodiments;

FIG. 15 is a diagram illustrating still another example of a steam generation system according to various embodiments;

FIG. 16 is a flowchart illustrating an example method for controlling a clothes care apparatus according to various embodiments;

FIG. 17 is a diagram illustrating an example of a steam generation system including a deionization module according to various embodiments;

FIG. 18 is a flowchart illustrating an example method for controlling a clothes care apparatus in a case where a deionization module is included a steam generation system of the clothes care apparatus according to various embodiments;

FIG. 19 is a diagram illustrating an example of a steam generation system including a bypass flow path according to various embodiments;

FIG. 20 is a diagram illustrating another example of a steam generation system including a bypass flow path according to various embodiments;

FIG. 21 is a diagram illustrating still another example of a steam generation system including a bypass flow path according to various embodiments;

FIG. 22 is a flowchart illustrating an example method for controlling a clothes care apparatus in a case where a bypass flow path is included in a steam generation system of the clothes care apparatus according to various embodiments;

FIG. 23 is a diagram illustrating one example of a steam generation system including a sterilization device according to various embodiments;

FIG. 24 is a diagram illustrating another example of a steam generation system including a sterilization device according to various embodiments; and

FIG. 25 is a diagram illustrating the other example of a steam generation system including a sterilization device according to various embodiments.

### DETAILED DESCRIPTION

Various example embodiments described in the disclosure and configurations shown in the accompanying drawings are merely examples, and various modifications may replace the various embodiments and the drawings of the disclosure at the time of filing of the application. Like reference numerals or symbols denoted in the drawings of the disclosure are members or components that perform the substantially same functions.

A singular form of a noun corresponding to an item may include one item or a plurality of the items, unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The term “and/or” includes any and all combinations of one or more of a plurality of associated listed items.

It will be understood that the terms “first”, “second”, or the like, may be used only to distinguish one component from another, not intended to limit the corresponding component in other aspects (e.g., importance or order).

When it is said that one (e.g., first) component is “coupled” or “connected” to another (e.g., second) component, with or without the terms “functionally” or “communicatively”, it may refer, for example to one component being connected to the other component directly (e.g., by wire), wirelessly, or through a third component.

It will be understood that when the terms “includes,” “comprises,” “including,” and/or “comprising,” when used in this disclosure, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it may be directly on the other component or intervening components may also be present.

The terms “front,” “rear,” “left,” “right,” “upper,” “lower,” etc., used in the following description are defined based on the drawings, and the shape and position of each component are not limited by these terms.

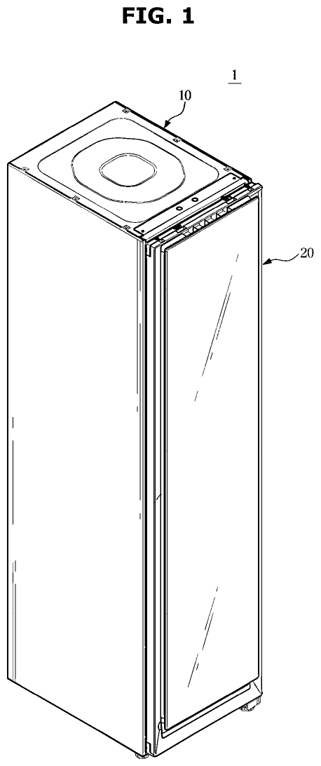

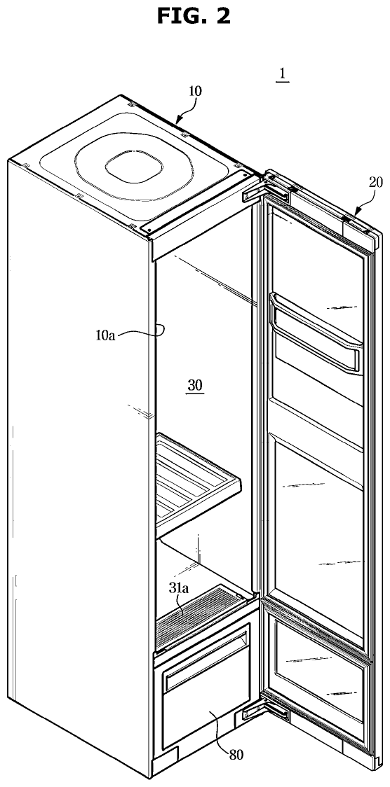

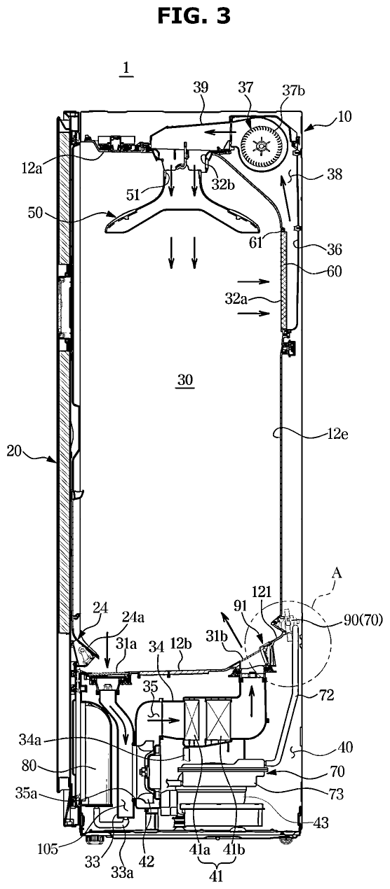

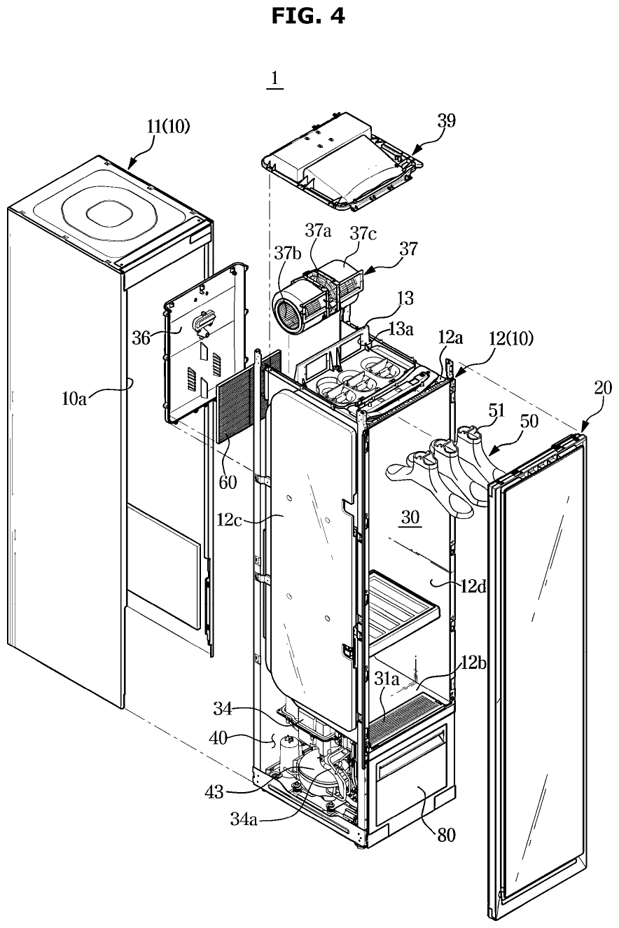

FIG. 1 is a perspective view illustrating an example clothes care apparatus according to various embodiments. FIG. 2 is a perspective view illustrating a clothes care apparatus with an open door according to various embodiments. FIG. 3 is a side cross-sectional view of a clothes care apparatus according to various embodiments. FIG. 4 is an exploded perspective view of a clothes care apparatus according to various embodiments.

Referring to FIG. 1, FIG. 2, FIG. 3 and FIG. 4, a clothes care apparatus 1 may include a main body 10 forming an exterior, a door 20 rotatably coupled to the main body 10, a chamber 30 disposed in the main body 10 to accommodate clothes to be cared for, a garment support member 50 provided in the chamber 30 to hold a garment, and a machine room 40 provided with a heat exchanger 41 for dehumidifying or heating air in the chamber 30.

The main body 10 may have a hexahedral shape with one side open, and the chamber 30 may be formed in the main body 10. An opening 10a may be formed in a front side of the main body 10. The chamber 30 may be replaced by the term “garment care room” in that garments subject to be cared for are accommodated therein.

The door 20 is rotatably coupled to the main body 10 at the opening 10a to open and close the chamber 30. Although not shown, the door 20 may be installed via a connection member such as a hinge, link, or the like.

The main body 10 may include an outer cabinet 11 and an inner cabinet 12 disposed inside the outer cabinet 11.

The chamber 30 may form a space for accommodating garments. The chamber 30 may be formed with an upper side 12a, a lower side 12b, a left side 12c, a right side 12d, and a rear side 12e disposed on the inner cabinet 12. The front of the chamber 30 is formed to be open. Accordingly, an opening of the chamber 30 may be opened and closed together by the door 20 that opens and closes the opening 10a of the main body 10.

The chamber 30 may include a first airflow inlet 31a, a second airflow inlet 32a, a first airflow outlet 31b, and a second airflow outlet 32b.

The first airflow inlet 31a and the first airflow outlet 31b may be formed on the lower side 12b of the chamber 30. The first airflow inlet 31a may be disposed on a front portion of the lower side 12b of the chamber 30. The first airflow outlet 31b may be disposed at a rear portion of the lower side 12b of the chamber 30. The first airflow inlet 31a and the first airflow outlet 31b may be disposed close to each other.

The second airflow inlet 32a may be formed on an upper portion of the rear side 12e of the chamber 30. The second airflow outlet 32b may be formed at approximately the center of the upper side 12a of the chamber 30. The second airflow inlet 32a and the second airflow outlet 32b may be disposed close to each other.

At a lower portion of the main body 10, a water tank 80 may be detachably disposed from the main body 10. The water tank 80 may be disposed at a lower portion of the chamber 30, without being limited thereto.

The water tank 80 may collect various condensates (condensed water) generated from the clothes care apparatus 1, and may supply water to a steam generation device 70.

For example, the water tank 80 may recover various condensates generated by the clothes care apparatus 1 and supply the generated condensates to the steam generation device 70. The water stored in the water tank 80 may be supplied to the steam generation device 70 and used to form steam.

The water tank 80 may include a water supply port for supplying water to the steam generation device 70 and a drain port for recovering various condensates generated by the clothes care apparatus 1.

In an embodiment, a partition may not be formed in the water tank 80, e.g., the water tank 80 may be provided as an integrated water supply/drainage type.

The water tank 80 may be detachable from the main body 10. A user may dispose of water stored in the water tank 80, refill the water tank 80, or the like, as needed.

The water tank 80 may be positioned in front of the machine room 40. The machine room 40 may be positioned in the lower portion of the main body 10. The water tank 80 may be replaced by terms such as “water reservoir” or “water storage portion” in that water is stored therein, and may also be replaced by terms such as “water supply and drainage reservoir”, “integrated water supply/drainage reservoir”, and the like, in that water supplied to the steam generation device 70 and various condensates generated by the clothes care apparatus 1 are stored therein.

The machine room 40 may be positioned below the chamber 30. The machine room 40 may include the heat exchanger 41 that may dehumidify and heat the air inside the chamber 30 as needed.

Inside the machine room 40, the heat exchanger 41, a first fan 42, a compressor 43, and the steam generation device 70 may be disposed.

The heat exchanger 41 may supply hot air into the chamber 30. The heat exchanger 41 may include an evaporator 41a and a condenser 41b through which refrigerant circulates to dehumidify and heat the air.

The refrigerant absorbs latent heat of surrounding air while evaporating in the evaporator 41a of the heat exchanger 41, thereby condensing and removing moisture in the air. When the refrigerant is condensed in the condenser 41b through the compressor 43, latent heat may be released to the surrounding air, thereby heating the surrounding air. For example, the evaporator 41a and the condenser 41b may function as a heat exchanger, and the air introduced into the machine room 40 by the first fan 42 may be dehumidified and heated while passing sequentially through the evaporator 41a and the condenser 41b.

The air introduced into the machine room 40 from the chamber 30 by the first fan 42 may be dehumidified while passing through the heat exchanger 41.

For example, the heat exchanger 41 may be configured to dehumidify and/or heat the air in the chamber 30. As the heat exchanger 41 dehumidifies and/or heats the air inside the chamber 30, condensate may be discharged from the heat exchanger 41. As will be described in greater detail below, the condensate discharged from the heat exchanger 41 may be stored in a sump 105.

The sump 105 is a component for temporarily storing various condensates generated by the clothes care apparatus 1, and may include a container and/or structure for temporarily storing various condensates generated by the clothes care apparatus 1. For example, the sump 105 may include an interior space formed by a first duct 33, which will be described in greater detail below. As another example, the sump 105 may include an internal structure formed by the first duct 33.

The ducts 33 and 34 connecting the first airflow inlet 31a and the first airflow outlet 31b may be disposed in the machine room 40. For example, the ducts 33 and 34 may include the first duct 33 extending from the first airflow inlet 31a and the second duct 34 extending from the first airflow outlet 31b.

The first duct 33 may be connected to the first airflow inlet 31a of the chamber 30. The first duct 33 may be connected to the second duct 34. The second duct 34 may be connected to the first airflow outlet 31b.

One end of the first duct 33 may be connected to the first airflow inlet 31a of the chamber 30, and the other end of the first duct 33 may be connected to the second duct 34. One end of the second duct 34 may be connected to the first duct 33, and the other end of the second duct 34 may be connected to the first airflow outlet 31b of the chamber 30.

The second duct 34 may receive the evaporator 41a, the condenser 41b, and the first fan 42. The first duct 33 and the second duct 34 may be connected to the chamber 30, and form a first circulation flow path 35 that circulates between the chamber 30 and the first duct 33 and the second duct 34.

A communication port 35a through which the first duct 33 and the second duct 34 communicate with each other may be formed at a portion where the first duct 33 and the second duct 34 are connected. Air introduced into the first duct 33 by the first fan 42 may move to the second duct 34 through the communication port 35a.

Air in the chamber 30 may flow into the first circulation flow path 35 through the first airflow inlet 31a. The introduced air may be dehumidified and heated while passing through the heat exchanger 41, and the dehumidified and heated air may be discharged back to the chamber 30 through the first airflow outlet 31b.

In an embodiment of the disclosure, although it is illustrated as an example that the first airflow inlet 31a is disposed at the front of the chamber 30 and the first airflow outlet 31b is disposed at the rear of the chamber 30, the disclosure is not limited thereto. For example, the positions of the airflow inlet and airflow outlet may be varied as desired.

The first duct 33 may allow air introduced through the first airflow inlet 31a to be discharged to the first airflow outlet 31b. The air introduced through the first airflow inlet 31a may be dehumidified and/or heated by the heat exchanger 41 and discharged to the first airflow outlet 31b.

The first fan 42 may be positioned on the first circulation flow path 35 and may draw air from the chamber 30 into the first circulation flow path 35.

The clothes care apparatus 1 may further include the steam generation device 70 to generate steam by receiving water from the water tank 80 and spray the generated steam into the chamber 30. The steam generation device 70 may be disposed in the machine room 40. The steam generation device 70 may include a steam generator 73 connected to the water tank 80 to generate steam by receiving water from the water tank 80, a steam supply pipe 72 to guide the generated steam to a steam ejector 90, and the steam ejector 90 to spray the steam generated by the steam generator 73 into the chamber 30.

The steam ejector 90 may be disposed at a rear lower portion of the chamber 30.

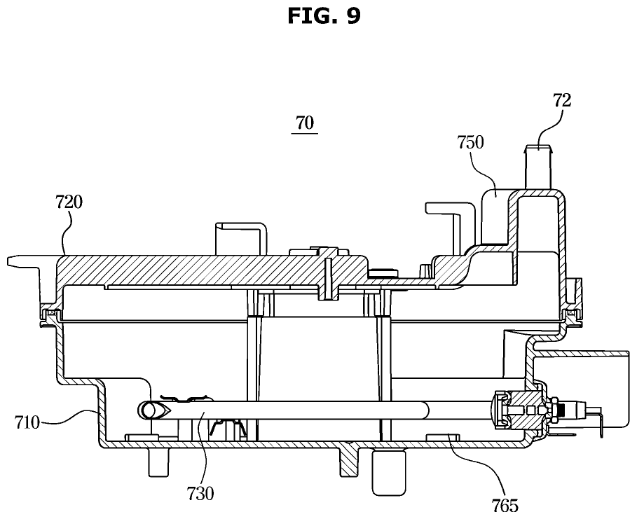

The steam generator 73 may include a space for storing water, e.g., water may be stored in the steam generator 73. In the disclosure, water in the steam generation device 70 may include water stored in the steam generator 73. The water stored in the steam generator 73 may include water stored in a case 710 (see FIG. 9). A heater 730 (see FIG. 9) for heating the water stored in the case 710 (see FIG. 9) may be installed in the case 710 (see FIG. 9) storing water.

The door 20 may include a door guide 24 for guiding movement of condensate. The door guide 24 may guide condensate that condenses and forms on a rear side of the door 20. The door guide 24 may include a curved portion 24a that is inclined downward from the rear side of the door 20 toward the chamber 30. Accordingly, the condensate formed on the rear side of the door 20 may descend under its own weight and move to the first airflow inlet 31a. The condensate moved to the first airflow inlet 31a may be stored in the sump 105. The condensate stored in the sump 105 may be moved to the water tank 80 through a first connection member 33a.

In an embodiment, the condensate discharged from the heat exchanger 41 and/or the condensate discharged from the steam generation device 70 may be stored in the sump 105.

A second connection member 34a may connect the second duct 34 and the first duct 33. The second connection member 34a may guide condensate in the second duct 34 to the first duct 33. The condensate guided to the first duct 33 may be stored in the sump 105. The condensate in the second duct 34 may include the condensate discharged from the heat exchanger 41 and/or the condensate discharged from the steam generation device 70. The condensate discharged from the steam generation device 70 may include condensate discharged from the steam ejector 90.

The first connection member 33a and/or the second connection member 34a may include a component capable of forming a flow path, such as a hose and/or pipe.

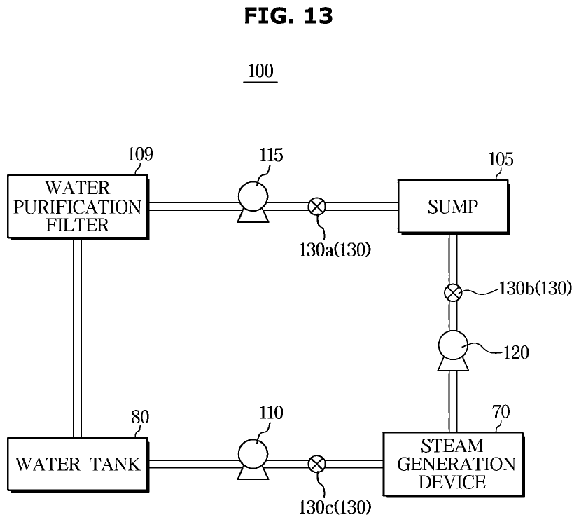

The condensate stored in the sump 105 may be moved to the water tank 80 through the first connection member 33a. As will be described in greater detail below, the clothes care apparatus 1 may include a sump pump 115 (see FIG. 13) to pump the condensate stored in the sump 105 to the water tank 80 through the first connection member 33a. Further, in an embodiment, the clothes care apparatus 1 may include a water purification filter 109 (see FIG. 13) disposed upstream of the water tank 80. Pumping the condensate stored in the sump 105 to the water tank 80 may include pumping the condensate stored in the sump 105 to the water purification filter 109.

The garment support member 5 in which a garment may be held and supported may be provided in the chamber 30. The garment support member 50 may be installed on the upper side 12a of the chamber 30. The garment support member 50 may be detachably installed in the chamber 30. At least one garment support member 50 may be provided. The garment support member 50 may be formed in the shape of a hanger for holding a garment.

The garment support member 50 may allow air to flow therein. Dirt or debris from the garment may be removed by air supplied into the garment support member 50. An air supply inlet 51 may be formed in the garment support member 50 to supply air to the garment.

The second airflow outlet 32b of the chamber 30 may communicate with the garment support member 50. Air discharged through the second airflow outlet 32b may be transferred to the garment support member 50 through the air supply inlet 51 and transferred to the inside of the garment held on the garment support member 50, or may be discharged outwardly of the air supply inlet 51 and transferred to the outside of the garment.

In an embodiment of the disclosure, although it is illustrated as an example that the second airflow outlet 32b is disposed above the garment support member 50, and air discharged through the second airflow outlet 32b is supplied to the inside and outside of the garment, the disclosure is not limited thereto. For example, the second airflow outlet may be formed in various sizes at various locations to spray air to the garment in various directions.

The clothes care apparatus 1 may include a second fan 37 for flowing internal air.

The clothes care apparatus 1 may include a third duct 36, and the second fan 37 may be installed in the third duct 36. The third duct 36 and the chamber 30 may communicate with each other, and thus the clothes care apparatus 1 may include a second circulation flow path 38 formed to allow air to circulate between the chamber 30 and the third duct 36. The second fan 37 may be disposed in the second circulation flow path 38.

The third duct 36 may be formed at the rear of the second airflow inlet 32a of the chamber 30. The third duct 36 may be positioned at the rear upper side of the chamber 30 and may include a filter member 60 therein. The third duct 36 may be coupled to a top cover 39 disposed at an upper portion of the chamber 30. The third duct 36 may be coupled to the top cover 39 and may have the second fan 37 installed therein.

The second fan 37 may be disposed at the rear upper portion of the chamber 30 and may include a blower motor 37a that generates a rotational force and at least one fan body 37b rotated by the blower motor. The fan body 37b may be accommodated by a fan case 37c.

The fan case 37c may be coupled to a duct bracket 13 positioned on the upper side 12a of the chamber 30. At least one duct hole 13a may be formed in the duct bracket 13, and the second fan 37 may be coupled to the at least one duct hole 13a to move air in the third duct 36 to the second airflow outlet 32b.

The third duct 36 may be connected to the second airflow inlet 32a of the chamber 30 and the top cover 39, and the top cover 39 may be connected to the third duct 36 and the second airflow outlet 32b.

One end of the third duct 36 may be connected to the second airflow inlet 32a of the chamber 30, and the other end thereof may be connected to the top cover 39. One end of the top cover 39 may be connected to the third duct 36, and the other end thereof may be connected to the second airflow outlet 32b.

The second airflow outlet 32b may communicate with the garment support member 50 to allow a portion of the air transferred from the third duct 36 to be transferred to the garment support member 50.

The second fan 37 disposed in the third duct 36 may allow air in the chamber 30 to be drawn in through the second airflow inlet 32a and be discharged to the second airflow outlet 32b.

The filter member 60 may be provided in the second airflow inlet 32a of the chamber 30. The second airflow inlet 32a may be formed at the rear side 12e of the chamber 30. A filter member installation portion 61 may be positioned on the rear side 12e of the chamber 30 to install the filter member 60. The second airflow inlet 32a may be formed at a position corresponding to the filter member installation portion 61.

In a case where the air in the chamber 30 flows into the third duct 36, the air may be filtered by the filter member 60 of the second airflow inlet 32a. The air flowing into the third duct 36 may be cleaned of dust and odor by the filter member 60. The air filtered by the filter member 60 may be discharged through the second fan 37 to the garment support member 50.

The filter member 60 may include a dust collecting filter (not shown) to remove dust or means for deodorizing.

A fragrance sheet 91 may be disposed in a portion of the inner cabinet 12 adjacent to the first airflow outlet 31b. The fragrance sheet 91 may be detachably coupled to the inner cabinet 12. Air discharged from the first airflow outlet 31b may provide a fragrance to a garment by the fragrance sheet 91.

To care for a garment, a user operates the clothes care apparatus 1 with the garment held on the garment support member 50 and the door 20 closed. In this instance, air in the chamber 30 may be circulated along the first circulation flow path 35 and the second circulation flow path 38.

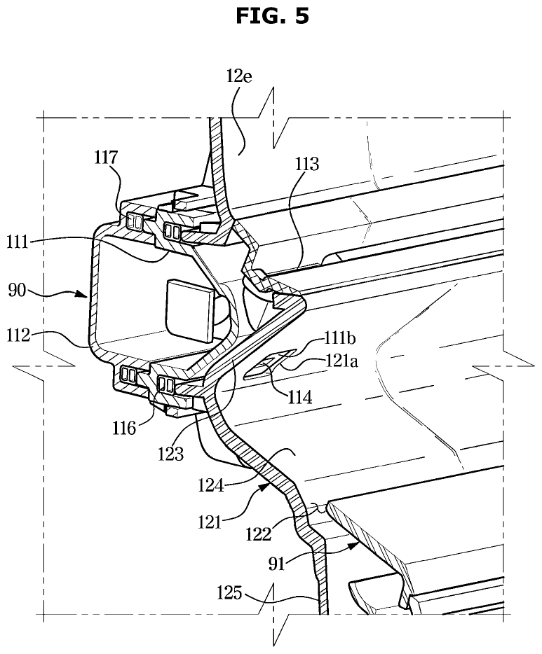

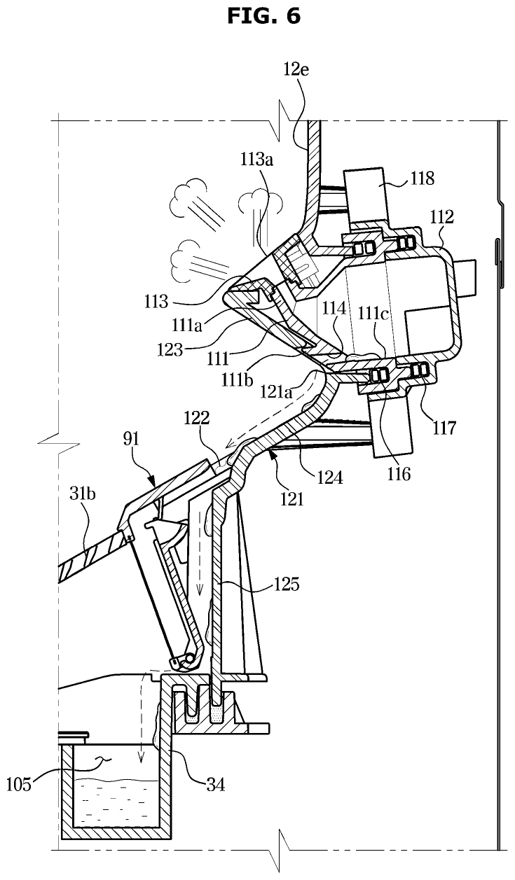

FIG. 5 is a partial sectional perspective view illustrating a portion in which a steam ejector of a steam generation device of a clothes care apparatus is disposed according to various embodiments. FIG. 6 is an enlarged perspective view of a portion A of FIG. 3 according to various embodiments.

Referring to FIG. 5 and FIG. 6, the steam ejector 90 may be disposed at the rear lower portion of the chamber 30. The steam ejector 90 may spray steam supplied from the steam generator 73 into the chamber 30. The steam ejector 90 may be connected to the steam supply pipe 72. The steam ejector 90 may include a steam nozzle 111 and a nozzle cover 112.

The steam nozzle 111 may include a steam outlet 111a spraying steam into the chamber 30, and a condensate outlet 111b discharging condensate generated from the steam ejector 90 into the chamber 30.

The steam outlet 111a may extend toward the upper side of the chamber 30 where garments are placed. The steam outlet 111a may be formed to spray steam supplied through the steam supply pipe 72 toward the upper side of the chamber 30. A spray nozzle 113 may be disposed at an end of the steam outlet 111a.

The spray nozzle 113 may be formed to spray steam broadly. The spray nozzle 113 may be formed in such a way that a size of an opening increases along a direction in which steam is sprayed. A steam spray outlet 113a through which steam is discharged may be formed at an end of the spray nozzle 113.

The condensate outlet 111b may be formed to discharge condensate to the lower side of the chamber 30. The condensate outlet 111b may be inclined downward toward the chamber 30 to allow the condensate to be discharged by gravity. For example, a lower side 111c of the spray nozzle 113 may be inclined downward toward the chamber 30, and the condensate outlet 111b may extend downward from the lower side 111c of the spray nozzle 113.

A condensate outlet port 114 through which condensate flows may be formed in the condensate outlet 111b. Condensate generated from the steam supplied to the steam ejector 90 may move to the condensate outlet 111b along the lower side 111c by its own weight, and may be discharged to the chamber 30 along the condensate outlet port 114 of the condensate outlet 111b.

A first sealing member 116 may be positioned at a portion where the steam nozzle 111 and the rear side 12e of the inner cabinet 12 are coupled. The first sealing member 116 may prevent and/or reduce steam from leaking through the portion where the steam nozzle 111 and the inner cabinet 12 are coupled. The first sealing member 116 may be positioned at a portion where the steam nozzle 111 and a guide plate 121 are coupled. The first sealing member 116 may prevent and/or reduce steam from leaking through the portion where the steam nozzle 111 and the guide plate 121 are coupled.

The nozzle cover 112 may cover the rear of the steam nozzle 111. The nozzle cover 112 may include a nozzle fixing portion 118 for fixing the steam ejector 90 to the rear of the inner cabinet 12. The nozzle fixing portion 118 may be fixed to the guide plate 121.

A second sealing member 117 may be positioned at a portion where the steam nozzle 111 and the nozzle cover 112 are coupled. The second sealing member 117 may prevent and/or reduce steam from leaking through the portion where the steam nozzle 111 and the nozzle cover 112 are coupled.

The clothes care apparatus 1 may include the guide plate 121 to guide condensate discharged through the condensate outlet port 114 to the second duct 34 disposed in the machine room 40.

The guide plate 121 may be mounted on the inner cabinet 12, and may form a drain 122 that communicates the chamber 30 with the machine room 40. Condensate may be moved to the second duct 34 of the machine room 40 through the drain 122. As described above, the condensate moved to the second duct 34 of the machine room 40 may be guided to the first duct 33 through the second connection member 34a, and the condensate guided to the first duct 33 may be stored in the sump 105.

The guide plate 121 may include a seating portion 123 on which the steam ejector 90 is seated, a first guide portion 124 that guides the condensate discharged from the condensate outlet port 114 to the drain 122, and a second guide portion 125 that guides the condensate flowing into the machine room 40 through the drain 122 to the second duct 34.

The seating portion 123 may be inclined upward toward the chamber 30 to allow the steam nozzle 111 of the steam ejector 90 to be seated. The seating portion 123 may include an outlet insertion hole 121a into which the condensate outlet 111b of the steam nozzle 111 is inserted. The steam nozzle 111 may discharge condensate to the drain 122 as the condensate outlet 111b is inserted into the outlet insertion hole 121a.

The first guide portion 124 may be inclined downward from a lower end of the seating portion 123 toward the chamber 30. The first guide portion 124 may be inclined downward to allow the condensate discharged from the condensate outlet port 114 to move to the machine room 40 by its own weight. The drain 122 through which condensate flows into the machine room 40 may be disposed at a lower end of the first guide portion 124.

The second guide portion 125 may extend downward from a lower end of the first guide portion 124. The second guide portion 125 may extend from the first guide portion 124 toward the second duct 34. The second guide portion 125 may guide condensate flowing into the machine room 40 through the drain 122 to the second duct 34. The second guide portion 15 may be coupled to the second duct 34.

According to the above-described configuration, the clothes care apparatus 1 according to an embodiment of the disclosure may guide condensate, generated from the steam ejector 90, to the second duct 34 of the machine room 40 and move the condensate to the sump 105 through the guide plate 121 without a separate drainage device for moving the condensate to the sump 105, e.g., the clothes care apparatus 1 may have a relatively simple configuration.

In other words, in the clothes care apparatus 1 according to an embodiment of the disclosure, the condensate generated from the steam ejector 90 may sequentially pass through the second duct 34 and the first duct 33 by its own weight and then move to the water tank 80 by an operation of the sump pump 115, and thus the condensate generated from the steam ejector 90 may be recovered to the water tank 80 without a separate complicated device for recovering the condensate. The condensate generated from the steam ejector 90 may be collected in the sump 105 together with condensate generated from another component of the clothes care apparatus 1, and may be moved to the water tank 80. The clothes care apparatus 1 according to an embodiment of the disclosure may collect condensate at one location and recover the condensate to the water tank 80 through a relatively simple configuration without a separate device such as a hose for draining condensate at each component where the condensate is generated, and thus manufacturing costs may be reduced.

According to an embodiment, various condensates generated from the clothes care apparatus 1 may be stored in the sump 105. The various condensates generated from the clothes care apparatus 1 may include condensate discharged from the heat exchanger 41 and/or condensate discharged from the steam generation device 70.

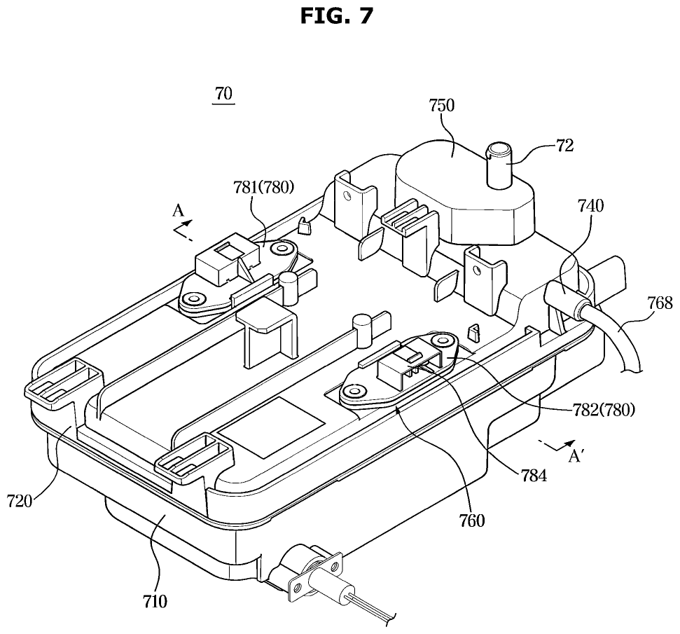

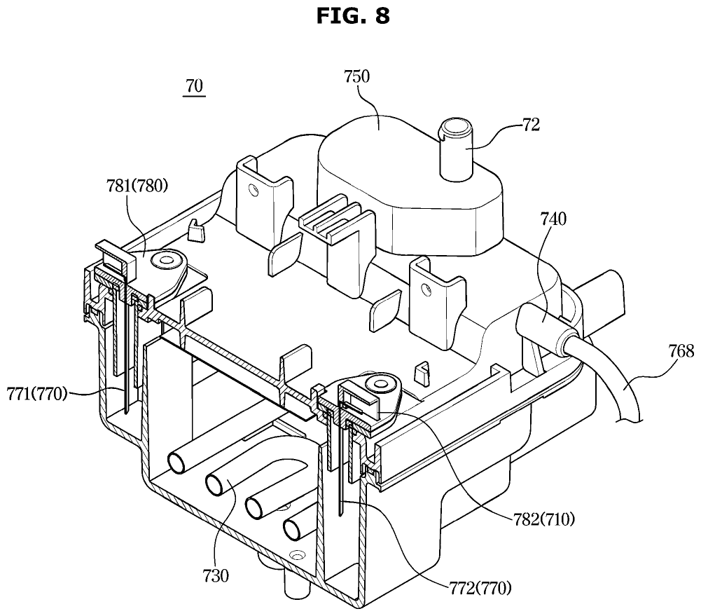

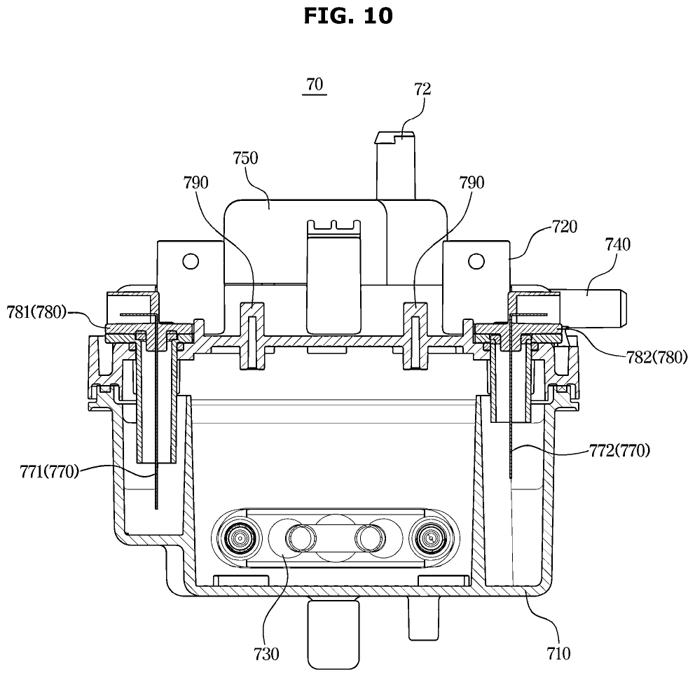

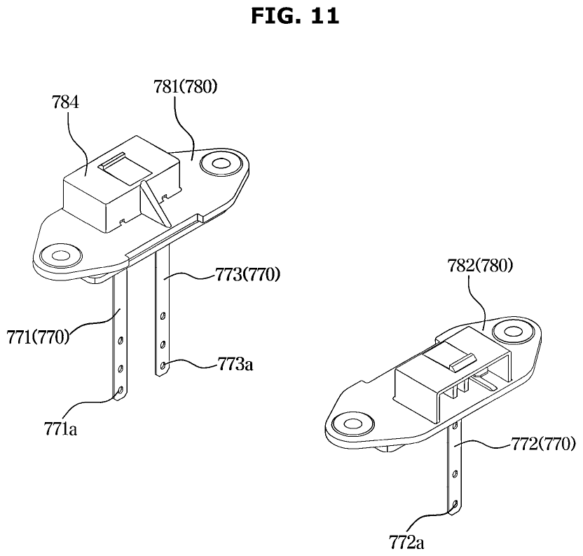

FIG. 7 is a perspective view illustrating an example steam generator of a steam generation device of a clothes care apparatus according to various embodiments. FIG. 8 is a perspective view of the steam generation device taken along line A-A′ of FIG. 7 according to various embodiments. FIG. 9 is a side cross-sectional view of a steam generator of a steam generation device of a clothes care apparatus according to various embodiments. FIG. 10 is a front cross-sectional view of a steam generator of a steam generation device of a clothes care apparatus according to various embodiments. FIG. 11 includes perspective views illustrating an example of an electrode sensor for detecting water level in a steam generation device of a clothes care apparatus according to various embodiments.

Referring to FIG. 7, FIG. 8, FIG. 9, FIG. 10 and FIG. 11, the steam generation device 70 may include the case 710 for storing water therein and a cover 720 coupled to an upper portion of the case 710. For example, the steam generator 73 may include the case 710 for storing water therein and the cover 720 coupled to the upper portion of the case 710.

The steam generation device 70 may include a contamination level sensor 765 for detecting a contamination level of water stored in the case 710. The contamination level of the water stored in the case 710 may include an ion concentration of the water stored in the case 710.

The contamination level sensor 765 may be positioned in the case 710. The contamination level sensor 765 may include an electrical conductivity sensor. The electrical conductivity sensor may measure an electrical conductivity of the water. A salinity or ion concentration of the water may be identified according to the electrical conductivity of the water.

According to the various embodiments, the contamination level sensor 765 may be replaced by an electrode sensor 770. In an embodiment, the contamination level sensor 765 may include a low water level electrode 771 and a common electrode 773 of the electrode sensor 770. By forming a potential difference in the low water level electrode 771 and the common electrode 773 of the electrode sensor 770, and measuring a current flowing in the low water level electrode 771 and the common electrode 773, the electrical conductivity of the water stored in the case 710 may be measured.

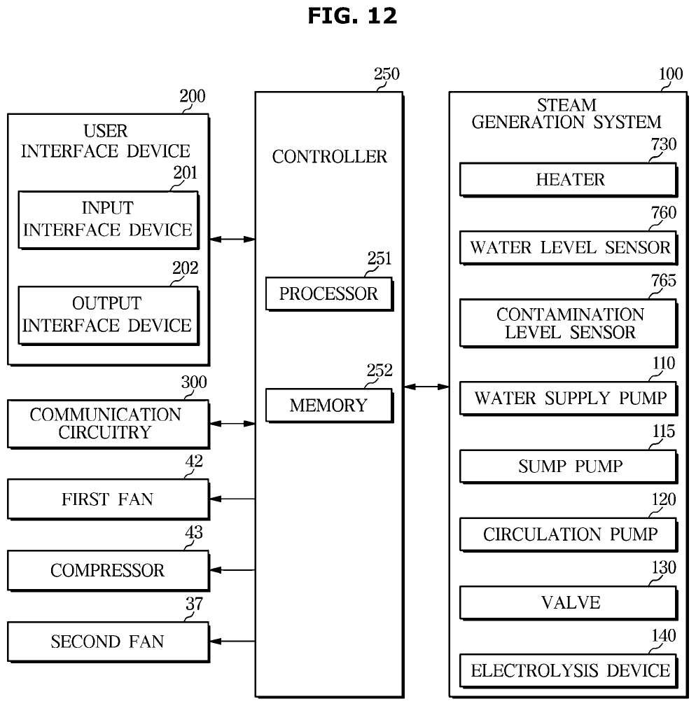

The steam generation device 70 may further include an electrolysis device 140 (see FIG. 12) to electrolyte the water stored in the case 710. The electrolysis device 140 may generate acidic water for removing scale formed in an inside of the case 710, an inside of the cover 720, or the heater 730 by electrolyzing the water stored in the case 710.

The case 710 may be supplied with water from the water tank 80 through a water supply connection member 768. For example, the water required to generate steam may be moved from the water tank 80 to the case 710 and may be stored. The water supply connection member 768 may include a component capable of forming a flow path, such as a hose and/or pipe. The clothes care apparatus 1 may include a water supply pump 110 (see FIG. 13) for supplying water stored in the water tank 80 to the steam generation device 70 through the water supply connection member 768.

The case 710 may be formed in a substantially rectangular parallelepiped shape, without being limited thereto.

The case 710 may be coupled to the cover 720, and may form a storage space inside.

The water required to generate steam may be stored in the storage space formed by coupling the case 710 to the cover 720.

The steam generation device 70 may include the heater 730 disposed inside the case 710 to heat the water stored in the case 710.

The heater 730 may be installed adjacent to a bottom side of the case 710 to heat the water in the case 710 regardless of whether the water level of the water in the case 710 is high or low. The heater 730 may be installed to directly heat the water in a state where the heater 730 is completely submerged in the water as water flows into the case 710.

The heater 730 may include a sheath heater that has high thermal efficiency and may heat water in a relatively short time, without being limited thereto. For example, the heater 730 may include a coil heater that heats water stored in the case 710 outside of the case 710, or the like.

The case 710 may be provided with a separate temperature sensor (not shown) to measure a temperature of the water stored in the case 710. In addition, a heater temperature sensor (not shown) such as a thermo-fuse may be installed in the case 710 to prevent or avoid the heater 730 being damaged by overheating. However, the disclosure is not limited thereto.

The cover 720 may include a water supply portion 740 coupled to the water supply connection member 768, and a discharge portion 750 connected to the steam supply pipe 72 for supplying the chamber 30 with steam generated by heating the water introduced into the case 710 with the heater 730.

The steam generation device 70 may include a water level sensor 760 that is installed on the cover 720 and detects a water level in the case 710.

The water level sensor 760 may detect the level of water stored in the case 710. In a case where the level of the water stored in the case 710 detected by the water level sensor 760 is higher than a reference value, the clothes care apparatus 1 may stop supplying water to the steam generation device 70 and operate the heater 730 to generate steam.

The water level sensor 760 may include the electrode sensor 770 extending toward the bottom side of the case 710. In addition, the water level sensor 760 may include a housing 780 that may support the electrode sensor 770 and is detachably coupled to the cover 720.

The electrode sensor 770 may be installed at an appropriate height to be spaced apart from the bottom side of the case 710 to detect the level of water to be stored in the case 710.

The housing 780 may be fixed to the cover 720 by a fixing member 790 (e.g. a bolt, or the like). A socket portion 784 may be positioned on an upper side of the housing 780 for electrical connection between the water level sensor 760 and a controller 250 (see FIG. 12).

The housing 780 may include a first housing 781 and a second housing 782. The first housing 781 and the second housing 782 may each be coupled to both sides of the cover 720.

The electrode sensor 770 may include the low water level electrode 771 detecting a low water level in the case 710, and a high water level electrode 772 detecting a high water level in the case 710.

The low water level electrode 771 may be positioned above the heater 730. An upper end of the low water level electrode 771 may be supported by the first housing 781, and a lower end of the low water level electrode 771 may be positioned above the heater 730 to be spaced apart from the heater 730.

The low water level electrode 771 may include a first detection portion 771a. The first detection portion 771a may be positioned at the lower end of the low water level electrode 771 and may detect the water level in the case 710.

The high water level electrode 772 may be positioned above the heater 730. An upper end of the high water level electrode 772 may be supported by the second housing 782, and a lower end of the high water level electrode 772 may be positioned above the heater 730 to be spaced apart from the heater 730.

The high water level electrode 772 may include a second detection portion 772a. The second detection portion 772a may be positioned at the lower end of the high water level electrode 772 and may detect the water level in the case 710.

The high water level electrode 772 may be formed to have a shorter length than the low water level electrode 771. According to the above configuration, the second detection portion 772a may be positioned at a higher position than the first detection portion 771a.

The electrode sensor 770 may include the common electrode 773.

The common electrode 773 may be supported by the first housing 781. For example, the common electrode 773 may be positioned adjacent to the low water level electrode 771. In addition, the common electrode 773 may have the same length as the low water level electrode 771.

The common electrode 773 may include a third detection portion 773a. The third detection portion 773a may be positioned at a lower end of the common electrode 773, and may detect the water level in the case 710.

The common electrode 773 may be electrically connected to at least one of the low water level electrode 771 or the high water level electrode 772 via water. According to the above configuration, the water level sensor 760 may detect the water level in the case 710.

Water may flow into the case 710 through the water supply portion 740. The water introduced into the case 710 may be heated by the heater 730 and converted into steam.

Steam may be supplied to the steam ejector 90 through the discharge portion 750 of the case 710. The steam ejector 90 may spray steam into the chamber 30. The steam sprayed into the chamber 30 may increase a humidity of air in the chamber 30. The humid air in the chamber 30 may be dehumidified by the heat exchanger 41. The heat exchanger 41 may dehumidify the humid air in the chamber 30 and discharge condensate. The condensate discharged from the heat exchanger 41 may be stored in the sump 105. The condensate stored in the sump 105 may be recovered to the water tank 80.

The water stored in the case 710 may be hard water containing a large amount of minerals. In a case where hard water is heated and forms on the inside of the case 710 or the cover 720, scale may form in the case 710 or the cover 720, or on the heater 730 due to the minerals contained in the hard water.

In addition, in a case where water is stored in the case 710 for a long time, a contamination level of the water stored in the case 710 increases.

FIG. 12 is a block diagram illustrating an example configuration of a clothes care apparatus according to various embodiments.

Referring to FIG. 12, the clothes care apparatus 1 according to an embodiment may include the first fan 42, the compressor 43, the second fan 37, the steam generation system 100, a user interface device 200, communication circuitry 300, and/or a controller (e.g., including at least one processor comprising processing circuitry) 250.

The first fan 42 may allow air in the chamber 30 to be discharged back to the chamber 30 through the machine room 40, the evaporator 41a, and the condenser 41b. The first fan 42 may operate based on a control signal from the controller 250.

The compressor 43 may compress refrigerant supplied to the heat exchanger 41. The compressor 43 may operate based on a control signal from the controller 250.

The second fan 37 may circulate the air in the chamber 30 back into the chamber 30 through the second airflow outlet 32b or the garment support member 50. The second fan 37 may operate based on a control signal from the controller 250.

The steam generation system 100 may supply steam to the chamber 30.

The steam generation system 100 may include the water tank 80 and the steam generation device 70 that generates steam using water supplied from the water tank 80 and sprays the generated steam into the chamber 30.

As described above, the steam generation device 70 may include the heater 730. The heater 730 may operate based on a control signal from the controller 250.

The steam generation device 70 may include the water level sensor 760. The water level sensor 760 may transmit data and/or information about a level of water in the steam generation device 70 (water stored in the case 710) to the controller 250.

The steam generation device 70 may include the contamination level sensor 765. The contamination level sensor 765 may transmit data and/or information about a contamination level of the water in the steam generation device 70 (water stored in the case 710) to the controller 250.

The steam generation system 100 may include various components for supplying water stored in the water tank 80 to the steam generation device 70. For example, the steam generation system 100 may include the water supply pump 110 and at least one connection member (e.g., water supply connection member 768) for supplying the water stored in the water tank 80 to the steam generation device 70.

The steam generation system 100 may include various components for supplying water in the steam generation device 70 and/or water stored in the sump 105 to the water tank 80.

In an embodiment, the steam generation system 100 may include the circulation pump 120 and at least one connection member for supplying water in the steam generation device 70 to the water tank 80. The connection member for supplying water in the steam generation device 70 to the water tank 80 may be connected to the water purification filter 109.

In an embodiment, the steam generation system 100 may include the circulation pump 120 and at least one connection member for supplying water in the steam generation device 70 to the sump 105.

In an embodiment, the steam generation system 100 may include at least one connection member (e.g., first connection member 33a) for supplying water stored in the sump 105 to the water tank 80, and the sump pump 115. The at least one connection member for supplying water stored in the sump 105 to the water tank 80 may be connected to the water purification filter 109.

The steam generation system 100 may further include at least one valve 130 configured to open and close at least one flow path formed by the at least one connection member for supplying water in the steam generation device 70 to the water tank 80 and/or the sump 105, and/or at least one flow path formed by the at least one connection member for supplying water stored in the sump 105 to the water tank 80, and/or at least one flow path formed by the at least one connection member for supplying water stored in the water tank 80 to the steam generation device 70.

The steam generation system 100 may include the water purification filter 109 for purifying and/or softening the water in the steam generation device 70 and/or the water stored in the sump 105 before supplying the water to the water tank 80.

The water purification filter 109 may include a filter capable of removing ions (e.g., ion exchange resin filter, electrochemical filter) and/or a filter required for water purification (e.g., free carbon filter, hollow membrane filter, etc.).

The steam generation system 100 may include the electrolysis device 140 for electrolyzing water in the steam generation device 70.

According to various embodiments, the steam generation system 100 may further include a sterilization device 160 for sterilizing water stored in the water tank 80. The sterilization device 160 for sterilizing water stored in the water tank 80 may include an ultraviolet irradiation portion (e.g., ultraviolet lamp). For example, the sterilization device 160 may be installed in a flow path connected to the water tank 80 and may be configured to irradiate ultraviolet light to water flowing in a separate flow path connected to the water tank 80.

The steam generation system 100 may include a sterilization pump 160p that pumps water stored in the water tank 80 into a flow pathway (hereinafter referred to as the “sterilization flow pathway”) in which the sterilization device 160 is installed. The water pumped by the sterilization pump 160p may be retrieved to the water tank 80 via the sterilization flow path.

Various components (e.g., heater 730, water supply pump 110, sump pump 115, circulation pump 120, valve 130, electrolysis device 140, the sterilization device 160, the sterilization pump 160p) of the steam generation system 100 may be controlled based on a control signal from the controller 250.

The user interface device 200 may allow a user and the clothes care apparatus 1 to interact with each other.

The user interface device 200 may include at least one input interface device 201 and at least one output interface device 202, each of which may include various interface circuitry.

The at least one input interface device 201 may convert sensory information received from a user into an electrical signal.

The at least one input interface device 201 may include a power button, a course selection button, an operation/pause button, and/or a communication button.

Each button may include a visual indicator (e.g., text, icon, etc.) that may indicate its function.

The power button is a button for turning on or off the power of the clothes care apparatus 1.

The course selection button is a button for selecting a course for the clothes care apparatus 1.

The course selection button may include a button for selecting a course for caring for garments stored in the chamber 30.

Upon selection of the course selection button, at least one course corresponding to clothes care may be displayed on the output interface device 202 (e.g., display), and the user may select a desired course using a direction selection button. The at least one course may include a variety of courses, such as a standard course, bulky item care course, sterilization course, fine dust course, quick course, school uniform course, denim course, coat course, wool/knit course, suit course, and the like.

Upon selection of the operation button after a course for clothes care is selected, the controller 250 may control components (e.g., compressor 43, steam generation system 100, first fan 42 and/or second fan 37) of the clothes care apparatus 1 according to an algorithm of the selected course to perform the selected course.

The operation/pause button is a button for operating the selected course or temporarily stopping a running course.

The communication button is a button for communication settings of the clothes care apparatus 1. Through the communication button, the clothes care apparatus 1 may connect to a nearby Access Point (AP). The clothes care apparatus 1 may communicate with an external device, such as a server, user device, and other home appliances, through the nearby access point.

The at least one input interface device 201 may include, for example, a tact switch, a push switch, a slide switch, a toggle switch, a micro switch, a touch switch, a touch pad, a touch screen, a jog dial, and/or a microphone.

In the disclosure, “button” may be replaced by an user interface (UI) element, a tact switch, a push switch, a slide switch, a toggle switch, a micro switch, a touch switch, a touch pad, a touch screen, a jog dial, and/or a microphone.

The at least one output interface device 202 may generate sensory information and convey information related to operations of the clothes care apparatus 1 to the user.

For example, the at least one output interface device 202 may convey information related to a clothes care course, operation time of the clothes care apparatus 1, and settings of the clothes care apparatus 1 to the user. Information about operations of the clothes care apparatus 1 may be output through a display, an indicator, voice, or the like. The at least one output interface device 202 may include, for example, a Liquid Crystal Display (LCD) panel, a Light Emitting Diode (LED) panel, an indicator, a speaker, and the like.

The communication circuitry 300 may communicate with an external device (e.g., a server, a user device, and/or a home appliance) for wired and/or wireless communication.

The communication circuitry 300 may include at least one of a short-range wireless communication module or a long-range wireless communication module.

The communication circuitry 300 may transmit data to an external device or receive data from the external device. For example, the communication circuitry 300 may establish communication with a server, a user device, and/or a home appliance, and transmit and receive various types of data.

For the communication, the communication circuitry 300 may establish a direct (e.g., wired) communication channel or a wireless communication channel between external devices, and support the performance of the communication through the established communication channel. According to an embodiment, the communication circuitry 300 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN)). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, or a server on a mobile communication network.

In an embodiment, the communication circuitry 300 may communicate with an external device such as a server, a user device and other home appliances through a nearby access point (AP). The access point may connect a local area network (LAN), to which the clothes care apparatus 1, another home appliance, or a user device is connected, to a wide area network (WAN) to which a server is connected. The clothes care apparatus 1, the other home appliance, or the user device may be connected to the server through the wide area network (WAN).

The controller 250 may include at least one processor 251 including various processing circuitry and a memory 252 and may process data collected from various components of the clothes care apparatus 1 (e.g., user interface device 200, communication circuitry 300, contamination level sensor 765, and/or water level sensor 760. The controller 250 may process user input entered through the user interface device 200 and/or the communication circuitry 300, and may perform operations corresponding to the user input.

For example, based on receiving a user input for starting a clothes care course from the user interface device 200, the controller 250 may control components (e.g., first fan 42, compressor 43, second fan 37, and/or steam generation system 100) of the clothes care apparatus 1 to perform the clothes care course according to a preset algorithm.

The clothes care courses may include s steam process.

The controller 250 may control the steam generation system 100 to perform the steam process. For example, the controller 250 may control the water supply pump 110 to supply water stored in the water tank 80 to the steam generation device 70 during the steam process. In an embodiment, the controller 250 may control the water supply pump 110 to supply the water stored in the water tank 80 to the steam generation device 70, based on a level of water in the steam generation device 70 being detected as a low water level by the water level sensor 760 during the steam process.

The controller 250 may operate the heater 730 to heat the water in the steam generation device 70 during the steam process.

In an embodiment, the controller 250 may control the sump pump 115 to pump the water stored in the sump 105 to the water purification filter 109 in response to completion of the clothes care course.

Once the water stored in the sump 105 is pumped to the water purification filter 109, the water stored in the sump 105 may be filtered by the water purification filter 109 and recovered to the water tank 80 disposed downstream of the water purification filter 109.

In an embodiment, the controller 250 may operate the circulation pump 120 based on a preset (e.g., specified) condition being satisfied.

The preset condition may include a contamination level of the water in the steam generation device 70 being greater than or equal to a preset contamination level. The preset condition may include a cumulative storage time of water in the steam generation device 70 reaching a preset time. The preset time may be a predefined time and may be changed based on user input received through the user interface device 200 and/or the communication circuitry 300.

The cumulative storage time of water in the steam generation device 70 may include a period during which the steam generation system 100 does not perform a circulation process.

The circulation process will be described in greater detail below.

For example, the cumulative storage time of the water in the steam generation device 70 may include an accumulated time during which the circulation pump 120, configured to pump water in the steam generation device 70 to the water purification filter 109 or the sump 105, is not operated.

A starting point of the cumulative storage time of the water in the steam generation device 70 may be an operation time (or operation end time) of the circulation pump 120.

For example, the cumulative storage time of the water in the steam generation device 70 may be reset and recalculated at an operation time (or operation end time) of the circulation pump 120.

In an embodiment, the controller 250 may control the circulation pump 120 based on a contamination level of water measured by the contamination level sensor 765. For example, the controller 250 may operate the circulation pump 120 for a preset period of time based on the contamination level of water measured by the contamination level sensor 765 being greater than or equal to a preset contamination level.

In an embodiment, the controller 250 may operate the water supply pump 110 together with the circulation pump 120 in a case where the circulation pump 120 is operated for the circulation process.

In an embodiment, the controller 250 may operate the sump pump 115 and the water supply pump 110 together with the circulation pump 120 in a case where the circulation pump 120 is operated for the circulation process.

In an embodiment, the controller 250 may control the electrolysis device 140 based on a contamination level of water measured by the contamination level sensor 765. For example, the controller 250 may operate the electrolysis device 140 for a preset period of time based on the contamination level of water measured by the contamination level sensor 765 being greater than or equal to the preset contamination level.

In an embodiment, the controller 250 may operate the water supply pump 110 based on a water level measured by the water level sensor 760. For example, based on a low water level being detected by the water level sensor 760, the controller 250 may operate the water supply pump 110 until a high water level is detected by the water level sensor 760.

The controller 250 may include hardware such as a Central Processing Unit (CPU), micom, or memory, and software such as a control program. For example, the controller 250 may include at least one memory 252 for storing an algorithm and program-type data for controlling the operation of components in the clothes care apparatus 1, and at least one processor 251 configured to perform the above-described operations and operations to be described in greater detail below using the data stored in the at least one memory 252. The memory 252 and the processor 251 may each be implemented as separate chips. The processor 251 may include one or more processor chips or may include one or more processing cores. The memory 252 may include one or more memory chips or one or more memory blocks. The memory 252 and the processor 251 may be implemented as a single chip. The processor 251 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 250 may be electrically connected to the first fan 42, the compressor 43, the second fan 37, the steam generation system 100, the user interface device 200, and/or the communication circuitry 300.

The components shown in FIG. 12 are simply examples of an example configuration of the clothes care apparatus 1 according to an embodiment. The clothes care apparatus 1 according to an embodiment may further include other components in addition to the components shown in FIG. 12, and may not include some of the components shown in FIG. 12.

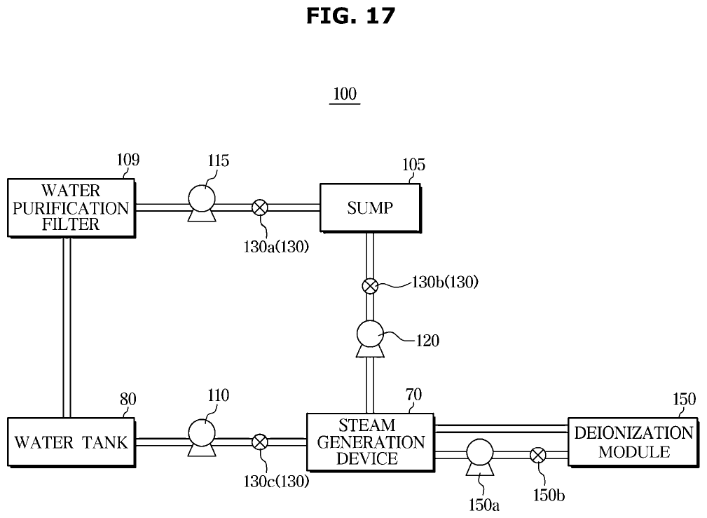

For example, the clothes care apparatus 1 according to an embodiment may not include the electrolysis device 140. As another example, the clothes care apparatus 1 according to an embodiment may not include the valve 130. As still another example, the clothes care apparatus 1 according to an embodiment may further include a deionization module 150 (see FIG. 17) and/or a deionization pump 150a.

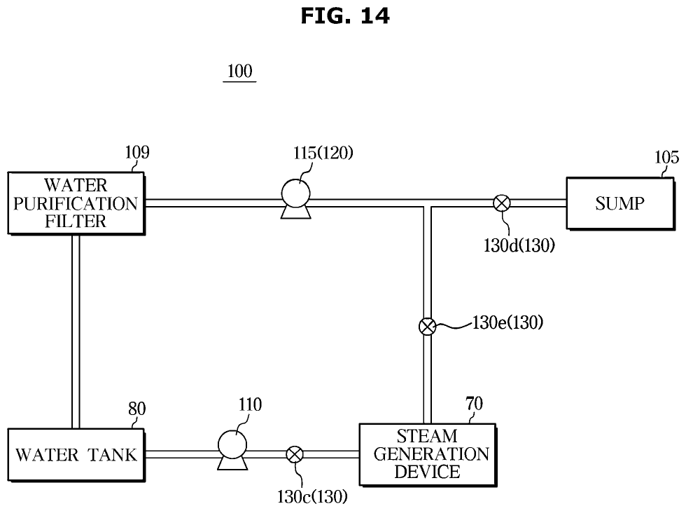

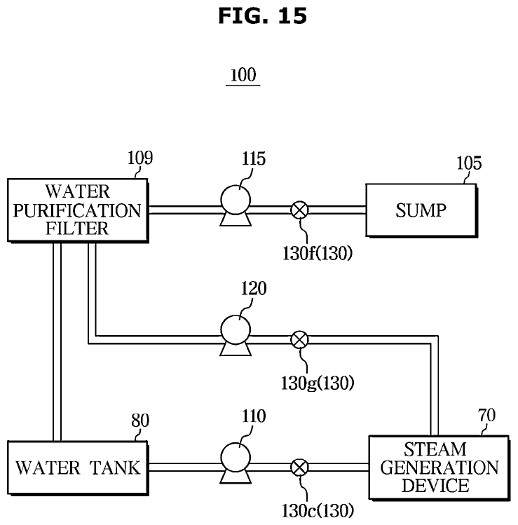

FIG. 13 is a diagram illustrating an example of a steam generation system according to various embodiments. FIG. 14 is a diagram illustrating another example of a steam generation system according to various embodiments. FIG. 15 is a diagram illustrating still another example of a steam generation system according to various embodiments.

Referring to FIG. 13, FIG. 14 and FIG. 15, the steam generation system 100 according to an embodiment may include the steam generation device 70, the sump 105, the water purification filter 109, and the water tank 80.

The steam generation system 100 according to an embodiment may include at least one circulation pump 120 for pumping water in the steam generation device 70 to the sump 105 or the water purification filter 109.

In the embodiment of FIG. 13, the circulation pump 120 may pump water in the steam generation device 70 to the sump 105. In the embodiment of FIG. 14, the circulation pump 120 and the sump pump 115 may be the same pump. In the embodiment of FIG. 15, the circulation pump 120 may pump water in the steam generation device 70 to the water purification filter 109.

The water purification filter 109 may be disposed upstream of the water tank 80. The water supplied to the water purification filter 109 may be filtered by the water purification filter 109 and move to the water tank 80 disposed downstream of the water purification filter 109. Pumping water to the water purification filter 109 may include pumping water to the water tank 80.

The steam generation system 100 according to an embodiment may include the sump pump 115 for pumping water stored in the sump 105 to the water purification filter 109.

In an embodiment, the controller 250 may operate the sump pump 115 for a preset period of time based on completion of a clothes care process (e.g., steam process) or clothes course.

In an embodiment, the controller 250 may operate the sump pump 115 based on completion of an operation of the water supply pump 110.

The steam generation system 100 according to an embodiment may include the water supply pump 110 for pumping water stored in the water tank 80 to the steam generation device 70.

The steam generation system 100 may include connection members to connect the steam generation device 70, the sump 105, the water purification filter 109, and the water tank 80. The steam generation system 100 may include flow paths formed by the connection members configured to connect the steam generation device 70, the sump 105, the water purification filter 109, and the water tank 80. The steam generation system 100 may include at least one valve 130 for opening and closing the flow paths formed by the connection members configured to connect the steam generation device 70, the sump 105, the water purification filter 109, and the water tank 80.

Referring to FIG. 13, the steam generation system 100 may include a valve 130a that opens and closes a flow path connecting the sump 105 and the water purification filter 109, a valve 130b that opens and closes a flow path connecting the sump 105 and the steam generation device 70, and a valve 130c that opens and closes a flow path connecting the water tank 80 and the steam generation device 70. According to various embodiments, at least one valve 130 among the plurality of valves 130a, 130b, and 130c may be omitted.

For example, in a case where the water stored in the sump 105 does not naturally flow into the water purification filter 109 due to factors such as gravity, the valve 130a that opens and closes the flow path connecting the sump 105 and the water purification filter 109 may be omitted. As another example, in a case where the water stored in the steam generation device 70 does not naturally flow into the sump 105 due to factors such as gravity, the valve 130b that opens and closes the flow path connecting the steam generation device 70 and the sump 105 may be omitted. As still another example, in a case where the water stored in the water tank 80 does not naturally flow into the steam generation device 70 due to factors such as gravity, the valve 130c that opens and closes the flow path connecting the water tank 80 and the steam generation device 70 may be omitted. A description of the valve 130c that opens and closes the flow path connecting the water tank 80 and the steam generation device 70 may be applied to all embodiments to be described in greater detail below, and thus, in the embodiments described below, the description of the valve 130c that opens and closes the flow path connecting the water tank 80 and the steam generation device 70 may not be repeated.

In an embodiment, operating the sump pump 115 may include opening the valve 130a connecting the sump 105 and the water purification filter 109. In an embodiment, operating the circulation pump 120 may include opening the valve 130b connecting the steam generation device 70 and the sump 105. In an embodiment, operating the water supply pump 110 may include opening the valve 130c connecting the water tank 80 and the steam generation device 70.

The controller 250 may operate the circulation pump 120 based on a preset condition being satisfied. As described above, the preset condition may include a contamination level of the water in the steam generation device 70 being greater than or equal to a preset contamination level and/or that a cumulative storage time of the water in the steam generation device 70 reaching a preset time. For example, the preset condition may include an event in which the water in the steam generation device 70 is likely to be contaminated.

In a case where the controller 250 operates the circulation pump 120, the controller 250 may operate the sump pump 115 and the water supply pump 110 together.

In a case where the circulation pump 120, the sump pump 115, and the water supply pump 110 operate together, the water in the steam generation device 70 may pass through the sump 105 and the water purification filter 109, and may be recovered to the water tank 80, and then recovered back to the steam generation device 70.

Referring to FIG. 14, the sump pump 115 and the circulation pump 120 may be the same pump. For example, the circulation pump 120 (and the sump pump 115) may pump the water in the steam generation device 70 to the water purification filter 109, or pump the water stored in the sump 105 to the water purification filter 109.

The steam generation system 100 may include a valve 130d that opens and closes a flow path connecting the sump 105 and the sump pump 115, and a valve 130e that opens and closes a flow path connecting the steam generation device 70 and the circulation pump 120.

In FIG. 14, the flow path connecting the sump 105 and the sump pump 115 may have a common flow path with the flow path connecting the steam generation device 70 and the circulation pump 120.

In FIG. 14, because the sump pump 115 and the circulation pump 120 are the same pump, the valves 130d and 130e are essentially required. According to various embodiments, the valve 130d that opens and closes the flow path connecting the sump 105 and the sump pump 115 and the valve 130e that opens and closes the flow path connecting the steam generation device 70 and the circulation pump 120 may be implemented as a single valve (e.g., a three-way valve). The valve 130d may be disposed in a portion of the flow path connecting the sump 105 and the sump pump 115, excluding the common flow path with the flow path connecting the steam generation device 70 and the circulation pump 120. The valve 130e may be disposed in a portion of the flow path connecting the steam generation device 70 and the circulation pump 120, excluding the common flow path with the sump 105 and the sump pump 115.

In an embodiment, operating the sump pump 115 may include controlling the valve 130d to open the flow path connecting the sump 105 and the sump pump 115. In an embodiment, operating the circulation pump 120 may include controlling the valve 130e to open the flow path connecting the steam generation device 70 and the circulation pump 120.

The controller 250 may operate the circulation pump 120 based on a preset condition being satisfied. As described above, the preset condition may include a contamination level of the water in the steam generation device 70 being greater than or equal to a preset contamination level and/or that a cumulative storage time of the water in the steam generation device 70 reaching a preset time. For example, the preset condition may include an event in which the water in the steam generation device 70 is likely to be contaminated.

In a case where the controller 250 operates the circulation pump 120, the controller 250 may operate the water supply pump 110 together. When operating the circulation pump 120, the controller 250 may control the valve 130d to close the flow path connecting the sump 105 and the sump pump 115.

In a case where the circulation pump 120 and the water supply pump 110 operate together, the water in the steam generation device 70 may be recovered to the water tank 80 directly through the water purification filter 109 without passing through the sump 105, and then may be recovered back to the steam generation device 70.

In an embodiment, in a case where the circulation pump 120 and the water supply pump 110 operate together, the flow discharge amount per unit time of the circulation pump 120 and the water supply pump 110 may be the same.

Referring to FIG. 15, a flow path connecting the sump 105 and the water purification filter 109 may not have a common flow path with a flow path connecting the steam generation device 70 and the water purification filter 109.

In FIG. 15, the flow path connecting the sump 105 and the water purification filter 109 and the flow path connecting the steam generation device 70 and the water purification filter 109 may be provided separately.

In an embodiment, the circulation pump 120 may pump water in the steam generation device 70 to the water purification filter 109. The sump pump 115 may pump water stored in the sump 105 to the water purification filter 109.

In FIG. 15, the steam generation system 100 may include a valve 130f that opens and closes the flow path connecting the sump 105 and the water purification filter 109, and a valve 130g that opens and closes the flow path connecting the steam generation device 70 to the water purification filter 109. According to various embodiments, at least one valve 130 among the plurality of valves 130f and 130g may be omitted.

For example, in a case where the water stored in the sump 105 does not naturally flow into the water purification filter 109 due to factors such as gravity, the valve 130f that opens and closes the flow path connecting the sump 105 and the water purification filter 109 may be omitted. As another example, in a case where the water stored in the steam generation device 70 does not naturally flow into the water purification filter 109 due to factors such as gravity, the valve 130g that opens and closes the flow path connecting the steam generation device 70 and the water purification filter 109 may be omitted.

In an embodiment, operating the sump pump 115 may include controlling the valve 130f to open the flow path connecting the sump 105 and the sump pump 115. In an embodiment, operating the circulation pump 120 may include controlling the valve 130g to open the flow path connecting the steam generation device 70 and the circulation pump 120.

The controller 250 may operate the circulation pump 120 based on a preset condition being satisfied. As described above, the preset condition may include a contamination level of the water in the steam generation device 70 being greater than or equal to a preset contamination level and/or that a cumulative storage time of the water in the steam generation device 70 reaching a preset time. For example, the preset condition may include an event in which the water in the steam generation device 70 is likely to be contaminated.

In a case where the controller 250 operates the circulation pump 120, the controller 250 may operate the water supply pump 110 together. When operating the circulation pump 120, the controller 250 may control the valve 130f to close the flow path connecting the sump 105 and the sump pump 115.

In a case where the circulation pump 120 and the water supply pump 110 operate together, the water in the steam generation device 70 may be recovered to the water tank 80 directly through the water purification filter 109 without passing through the sump 105, and then may be recovered back to the steam generation device 70.

In an embodiment, in a case where the circulation pump 120 and the water supply pump 110 operate together, the flow discharge amount per unit time of the circulation pump 120 and the water supply pump 110 may be the same.

According to the disclosure, the water in the steam generation device 70 may be kept clean even when a user does not use the clothes care apparatus 1 for a long time. In addition, according to the disclosure, the water stored in the water tank 80 may be kept clean even when the user does not change the water in the water tank 80. In addition, according to the disclosure, the water stored in the sump 105 may pass through the water purification filter 109 each time the water stored in the sump 105 is recovered to the water tank 80, and thus the water flowing into the water tank 80 may be purified water at all times.

The structure of the steam generation system 100 according to various embodiments is not limited to the embodiments illustrated in FIG. 13, FIG. 14 and FIG. 15. As long as a component (e.g., circulation pump 120) that may move the water in the steam generation device 70 to the water tank 80 after passing through the water purification filter 109 is included, such a component may be employed as the structure of the steam generation system 100 according to an embodiment of the disclosure.

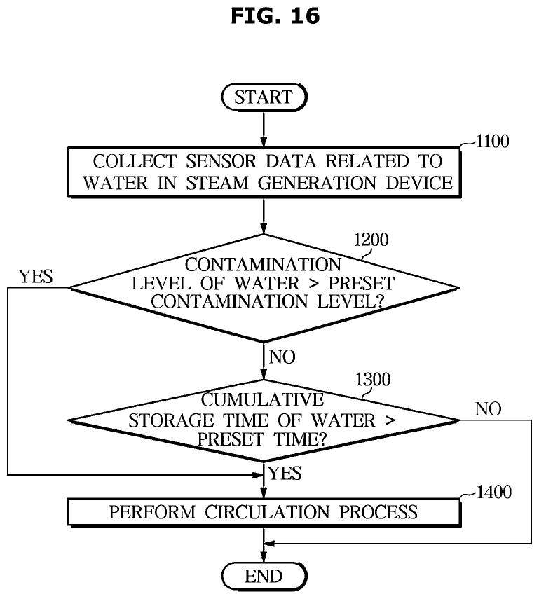

FIG. 16 is a flowchart illustrating an example method for controlling a clothes care apparatus according to various embodiments.

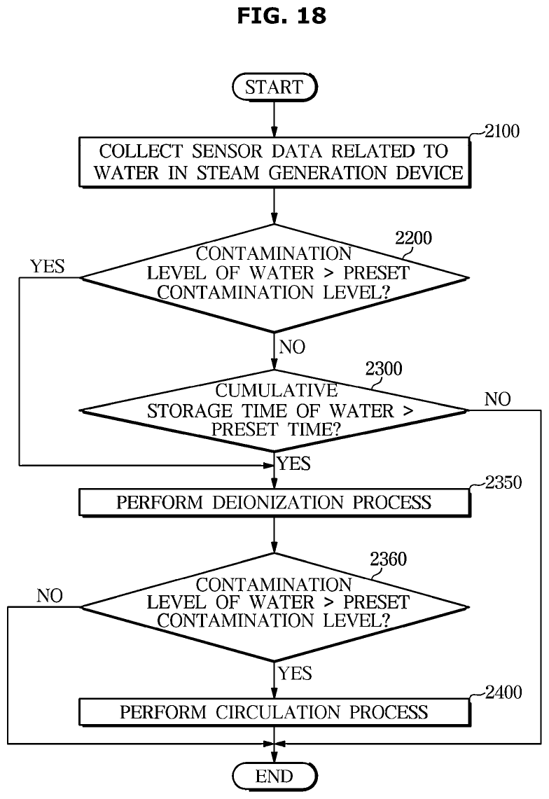

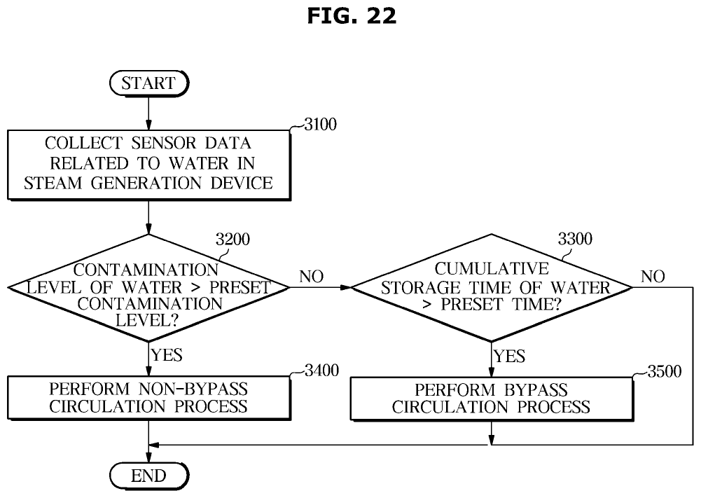

According to various embodiments, the clothes care apparatus 1 may perform operations shown in FIG. 16, FIG. 18, and FIG. 22, based on completion of a clothes care process (e.g., steam process) or clothes course. However, the time at which the clothes care apparatus 1 performs the operations shown in FIG. 16, FIG. 18, and FIG. 22 is not limited thereto. For example, the clothes care apparatus 1 may periodically perform the operations shown in FIG. 16, FIG. 18, and FIG. 22.

Referring to FIG. 16, the clothes care apparatus 1 according to an embodiment may collect sensor data related to water in the steam generation device 70 (1100).

For example, the water level sensor 760 may measure a water level in the steam generation device 70. As another example, the contamination level sensor 765 may measure a contamination level of water in the steam generation device 70.

The controller 250 may receive data related to the water level in the steam generation device 70 from the water level sensor 760.

The controller 250 may receive data related to the contamination level of water in the steam generation device 70 from the contamination level sensor 765.

The clothes care apparatus 1 may determine whether preset conditions for starting a circulation process are satisfied (1200, 1300).

In an embodiment, the clothes care apparatus 1 may identify whether the contamination level of the water in the steam generation device 70 exceeds a preset contamination level (1200).

In an embodiment, the clothes care apparatus 1 may identify whether a cumulative storage time of the water in the steam generation device 70 has reached a preset time (1300).

The controller 250 may identify the contamination level of the water in the steam generation device 70 based on processing the data related to the contamination level of the water in the steam generation device 70 received from the contamination level sensor 765, and may determine whether the identified contamination level of the water in the steam generation device 70 exceeds the preset contamination level.

For example, the contamination level sensor 765 may be an electrical conductivity sensor, and the controller 250 may determine whether an electrical conductivity of the water in the steam generation device 70 exceeds a preset electrical conductivity (e.g., 700 uS/cm).

In an embodiment, based on the contamination level of the water in the steam generation device 70 being greater than or equal to the preset contamination level (Yes in operation 1200), the clothes care apparatus 1 may perform the circulation process (1400).

The controller 250 may identify the contamination level of the water in the steam generation device 70 based on processing the data related to the contamination level of the water in the steam generation device 70 received from the contamination level sensor 765, and may control the steam generation system 100 to perform the circulation process based on the identified contamination level of the water in the steam generation device 70 exceeding the preset contamination level.

In an embodiment, based on the cumulative storage time of the water in the steam generation device 70 reaching the preset time (e.g. 30 days) (Yes in operation 1300), the clothes care apparatus 1 may perform the circulation process (1400).

The cumulative storage time of the water in the steam generation device 70 reaching the preset time may include the cumulative storage time of the water in the steam generation device 70 exceeding the preset time. As described above, the cumulative storage time of the water in the steam generation device 70 may include the accumulated time during which the circulation pump 120 is not operated.

The controller 250 may calculate the accumulated time during which the circulation pump 120 is not operated, and may control the steam generation system 100 to perform the circulation process based on the accumulated time during which the circulation pump 120 is not operated reaching the preset time.

The circulation process may include a process that causes the water in the steam generation system 100 to circulate through the steam generation device 70, the sump 105 (which may be omitted), the water purification filter 109, and the water tank 80.

The clothes care apparatus 1 may pump the water in the steam generation device 70 to the sump 105 or the water purification filter 109 for the circulation process.

In an embodiment, the controller 250 may operate the circulation pump 120 for the circulation process.

Referring to FIG. 13, for the circulation process, the clothes care apparatus 1 may pump the water in the steam generation device 70 to the sump 105, and pump the water stored in the sump 105 to the water purification filter 109. The clothes care apparatus 1 may pump the water stored in the water tank 80 to the steam generation device 70 for the circulation process.

In an embodiment, the controller 250 may operate the sump pump 115 and the water supply pump 110 together with the circulation pump 120 for the circulation process.

Referring to FIG. 14 and FIG. 15, the clothes care apparatus 1 may pump the water in the steam generation device 70 to the water purification filter 109 for the circulation process. The clothes care apparatus 1 may pump the water stored in the water tank 80 to the steam generation device 70 for the circulation process.

In an embodiment, the controller 250 may operate the circulation pump 120 and the water supply pump 110 together for the circulation process.

According to the disclosure, in a case where the water in the steam generation device 70 is contaminated, the water may be filtered by the water purification filter 109 and recovered, and thus the water may be continuously reused.

In addition, according to the disclosure, a user is not required to change the water in the water tank 80, and thus user convenience may be improved.

According to various embodiments, the steam generation system 100 may further include an electrolysis device to electrolyze the water in the steam generation device 70. The clothes care apparatus 1 may operate the electrolysis device based on a preset condition being satisfied.

In an embodiment, the controller 250 may operate the electrolysis device based on the preset condition being satisfied. For example, the controller 250 may operate the electrolysis device for a preset period of time based on the preset condition being satisfied, and then start the circulation process.

By electrolyzing the water in the steam generation device 70, a small amount of acidic water may be generated, and scale formed in the case 710 or the cover 720, or on the heater 730 may be removed. In addition, the small amount of acidic water may be diluted by passing through the water purification filter or with a large amount of water during the circulation process, thereby utilizing as water for steam generation later.

FIG. 17 is a diagram illustrating an example of a steam generation system including a deionization module according to various embodiments.

FIG. 17 illustrates that the steam generation system 100 according to the embodiment of FIG. 13 further includes the deionization module 150. However, the steam generation system 100 according to the embodiments of FIG. 14 and FIG. 15 may also further include the deionization module 150, and operations to be described in greater detail below may also be applied to the steam generation system 100 according to the embodiments of FIG. 14 and FIG. 15.

Referring to FIG. 17, the steam generation system 100 according to an embodiment may further include the deionization module 150.

The deionization module 150 may include a filter capable of removing ions contained in water. For example, the deionization module 150 may include an ion exchange resin filter, a water. Reverse Osmosis Membrane (RO) filter, and/or a Capacitive Deionization (CDI) module.

The steam generation system 100 according to an embodiment may further include the deionization pump 150a configured to pump water in the steam generation device 70 to allow the water in the steam generation device 70 to flow back into the steam generation device 70 after passing through the deionization module 150.

The steam generation system 100 according to an embodiment may further include a valve 150b configured to open and close a flow path connecting the steam generation device 70 and the deionization module 150. According to various embodiments, in a case where the water stored in the steam generation device 70 does not naturally flow into the deionization module 150 due to factors such as gravity, the valve 150b may be omitted.

FIG. 18 is a flowchart illustrating an example method for controlling a clothes care apparatus in a case where a deionization module is included a steam generation system of the clothes care apparatus according to various embodiments.

Referring to FIG. 18, the clothes care apparatus 1 according to an embodiment may collect sensor data related to water in the steam generation device 70 (2100). A description of operation 2100 is omitted because the description overlaps with that of operation 1100 of FIG. 16.

The clothes care apparatus 1 may identify whether a contamination level of the water in the steam generation device 70 exceeds a preset contamination level (2200). A description of operation 2200 may not be repeated here because the description overlaps with that of operation 1200 of FIG. 16.

In an embodiment, the clothes care apparatus 1 may identify whether a cumulative storage time of the water in the steam generation device 70 has reached a preset time (2300). A description of operation 2300 may not be repeated here because the description overlaps with that of operation 1300 of FIG. 16.

In an embodiment, the clothes care apparatus 1 may perform a deionization process (2350), based on the contamination level of the water in the steam generation device 70 being greater than or equal to the preset contamination level (Yes in operation 2200).

In an embodiment, based on the cumulative storage time of the water in the steam generation device 70 reaching the preset time (e.g., 30 days) (Yes in operation 2300), the clothes care apparatus 1 may perform the deionization process (2350).

The deionization process may include a process of allowing the water in the steam generation device 70 to be recovered back to the steam generation device 70 after passing through the deionization module 150.

In an embodiment, for the deionization process, the clothes care apparatus 1 may pump the water in the steam generation device 70 to allow the water in the steam generation device 70 to flow back into the steam generation device 70 after passing through the deionization module. In an embodiment, the controller 250 may operate the deionization pump 150a for the deionization process. According to various embodiments, in a case where the deionization module 150 corresponds to a capacitive deionization module, the controller 250 may operate the deionization module 150 for the deionization process. Operating the deionization module 150 may include applying a voltage to both electrodes included in the capacitive deionization module.

In an embodiment, the clothes care apparatus 1 may perform a circulation process based on completion of the deionization process. For example, the controller 250 may operate the deionization pump for a preset period of time in response to a preset condition being satisfied, and operate the circulation pump 120 based on stopping the operation of the deionization pump.

In an embodiment, the clothes care apparatus 1 may identify whether the contamination level of the water in the steam generation device 70 exceeds the preset contamination level (2360), based on the deionization process being performed for the preset period of time.

The clothes care apparatus 1 may perform the circulation process (2400), based on the contamination level of the water in the steam generation device 70 exceeding the preset contamination level (Yes in operation 2360).

According to the disclosure, after first lowering the contamination level of the water in the steam generation device 70 through the deionization module 150, in a case where the contamination level of the water in the steam generation device 70 is not improved, the circulation process may be performed, and thus a life of the water purification filter 109 may be extended.

In addition, according to the disclosure, water ions in the steam generation device 70 may be efficiently removed by the deionization module 150.

According to various embodiments, the clothes care apparatus 1 may perform the deionization process based on the contamination level of the water in the steam generation device 70 being greater than or equal to the preset contamination level (Yes in operation 2200), and may perform the circulation process based on the cumulative storage time of the water in the steam generation device 70 reaching the preset time (e.g., 30 days) (Yes in operation 2300).

For example, the controller 250 may perform the circulation process based on the contamination level of the water in the steam generation device 70 not exceeding the preset contamination level and the cumulative storage time of the water in the steam generation device 70 reaching the preset time.

In an embodiment, the controller 250 may perform the deionization process, based on the contamination level of the water in the steam generation device 70 exceeding the preset contamination level and the cumulative storage time of the water in the steam generation device 70 not reaching the preset time.

The deionization process is for removing the contamination level of the water, and in a case where the contamination level of the water is lower than the preset contamination level, the deionization process is not required. However, in a case where the cumulative storage time of the water in the steam generation device 70 has reached the preset time, because suspended substances, and the like, may be present in the water in the steam generation device 70, the clothes care apparatus 1 may perform the circulation process instead of the deionization process.

According to various embodiments, the clothes care apparatus 1 may also sequentially perform the deionization process and the circulation process, based on the contamination level of the water in the steam generation device 70 being greater than or equal to the preset contamination level (Yes in operation 2200).

According to the disclosure, the steam generation system 100 may efficiently remove ions contained in the water in the steam generation system 100 by including the deionization module 150.

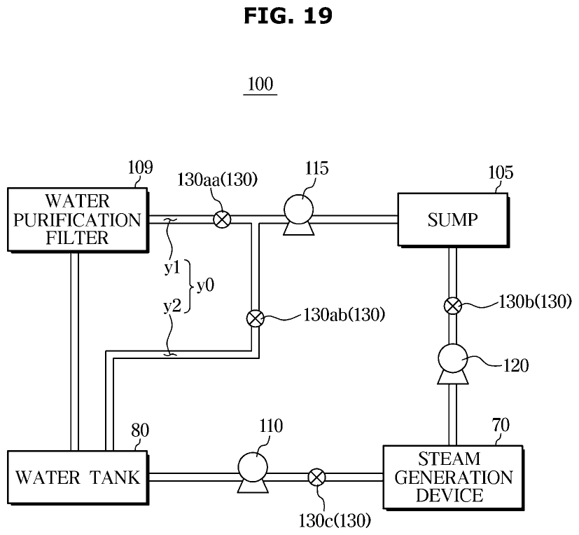

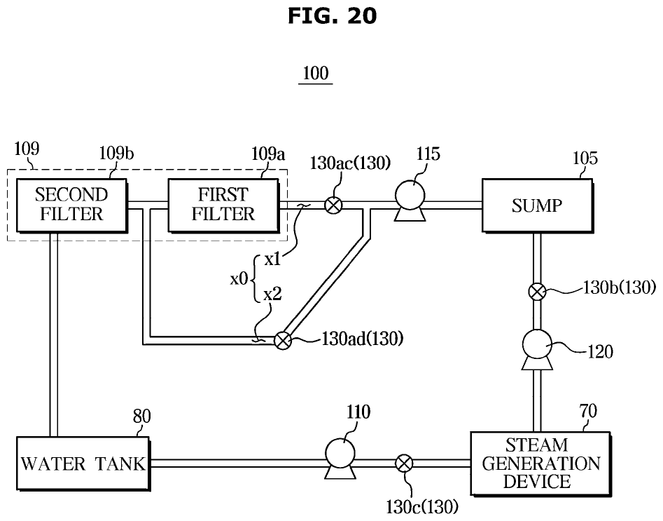

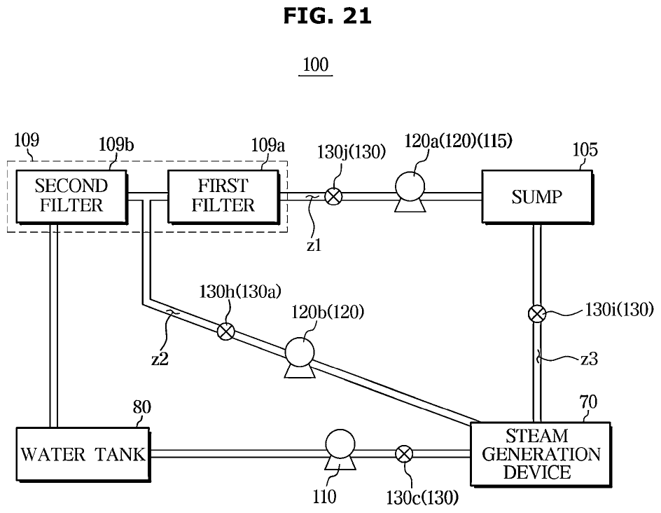

FIG. 19 is a diagram illustrating an example of a steam generation system including a bypass flow path according to various embodiments. FIG. 20 is a diagram illustrating another example of a steam generation system including a bypass flow path according to various embodiments. FIG. 21 is a diagram illustrating still another example of a steam generation system including a bypass flow path according to various embodiments.

The water tank 80 according to an embodiment of the disclosure is an integrated water supply/drainage water tank that stores both water supplied to the steam generation device 70 and various condensates generated from the clothes care apparatus 1. To this end, various condensates generated from the clothes care apparatus 1 may be temporarily stored in the sump 105, filtered by the water purification filter 109, and then recovered to the water tank 80.

Because the amount of water temporarily stored in the sump 105 is not large, filtering the water temporarily stored in the sump 105 through the water purification filter 109 does not significantly reduce a life of the water purification filter 109.

However, in a case where the water stored in the water tank 80 or the water in the steam generation device 70 is filtered by the water purification filter 109 during the circulation process, the life of the water purification filter 109 may be impaired.

Meanwhile, simply circulating the water stored in the water tank 80 and the water in the steam generation device 70 without going through a filter may help reduce a level of water contamination.

FIG. 19 is a diagram illustrating an example in which the steam generation system includes a bypass flow path that bypasses the water purification filter 109 and is directed to the water tank 80 according to various embodiments.

FIG. 19 illustrates that the steam generation system 100 according to the embodiment of FIG. 13 further includes a bypass flow path. However, the steam generation system 100 according to the embodiments of FIG. 14 and FIG. 15 may further include the bypass flow path, and operations to be described in greater detail below may also be applied to the embodiment in which the steam generation system 100 according to the embodiments of FIG. 14 and FIG. 15 further includes the bypass flow path.

Referring to FIG. 19, the circulation pump 120 may pump the water in the steam generation device 70 to the sump 105. The sump pump 115 may pump the water stored in the sump 105 to a branch flow path y0. The branch flow path y0 may include a first flow path y1 configured to connect the sump 105 and the water purification filter 109, and a second flow path y2 configured to connect the sump 105 and the water tank 80.

The first flow path y1 may be configured to allow the water supplied to the first flow path y1 to flow to the water purification filter 109.

The second flow path y2 may be configured to allow the water supplied to the second flow path y2 to flow to the water tank 80. The second flow path y2 may be defined as a bypass flow path in that the second flow path y2 allows the water supplied to the second flow path y2 to bypass the water purification filter 109 and flow into the water tank 80.

The steam generation system 100 according to an embodiment may include a first valve 130aa configured to open and close the first flow path y1 and a second valve 130ab configured to open and close the second flow path y2.

The valve 130aa configured to open and close the first flow path y1 and the valve 130ab configured to open and close the second flow path y2 may be implemented as a single valve (e.g., a three-way valve).

In an embodiment, in a case where the controller 250 operates the sump pump 115 to recover the condensate stored in the sump 105 to the water tank 80, the controller 250 may control at least one valve 130 to open the first flow path y1 and close the second flow path y2. For example, because the condensate stored in the sump 105 may contain contaminated substances, the clothes care apparatus 1 may open the first flow path y1, close the second flow path y2, and operate the sump pump 115 to recover the condensate stored in the sump 105, thereby allowing the condensate stored in the sump 105 to be recovered to the water tank 80 by passing through the water purification filter 109.

In an embodiment, for the circulation process, the controller 250 may operate the circulation pump 120, the sump pump 115, and the water supply pump 110, and may control the at least one valve 130 to open one of the first flow path y1 or the second flow path y2, and close the other.

For example, for the circulation process, the controller 250 may operate the circulation pump 120, the sump pump 115, and the water supply pump 110, and may control the first valve 130aa to open the first flow path y1, and control the second valve 130ab to close the second flow path y2. As another example, for the circulation process, the controller 250 may operate the circulation pump 120, the sump pump 115, and the water supply pump 110, and may control the first valve 130aa to close the first flow path y1, and control the second valve 130ab to open the second flow path y2

In a case where the circulation pump 120, the sump pump 115, and the water supply pump 110 operate while the first flow path y1 is closed and the second flow path y2 is open, the water in the steam generation device 70 may be circulated without passing through the water purification filter 109. The circulation process performed while the first flow path y1 is closed and the second flow path y2 is open may be defined as a bypass circulation process in that the water in the steam generation device 70 bypasses the water purification filter 109. The circulation process performed while the first flow path y1 is closed and the second flow path y2 is open may also be defined as a non-filtering circulation process in that the water in the steam generation device 70 is not filtered.

In a case where the circulation pump 120, the sump pump 115, and the water supply pump 110 operate while the first flow path y1 is open and the second flow path y2 is closed, the water in the steam generation device 70 may circulate by passing through the water purification filter 109. The circulation process performed while the first flow path y1 is open and the second flow path y2 is closed may be defined as a non-bypass circulation process in that the water in the steam generation device 70 passes through the water purification filter 109. The circulation process performed while the first flow path y1 is closed and the second flow path y2 is open may be defined as a filtering circulation process in that the water in the steam generation device 70 is filtered.

FIG. 20 and FIG. 21 illustrate an example in which the water purification filter 109 includes a first filter 109a and a second filter 109b disposed downstream of the first filter 109a, and the steam generation system includes a bypass flow path that bypasses the first filter 109a and is directed to the second filter 109b according to various embodiments.

Referring to FIG. 20 and FIG. 21, the water purification filter 109 may include the first filter 109a and the second filter 109b. The water tank 80 may be disposed downstream of the second filter 109b, and the second filter 109b may be disposed downstream of the first filter 109a. Water flowing into the first filter 109a may flow into the water tank 80 through the first filter 109a and the second filter 109b. Water flowing into the second filter 109b may flow into the water tank 80 through the second filter 109b.

The first filter 109a may be a filter capable of removing ions (e.g., ion exchange resin filter, electrochemical filter). The second filter 109b may be a filter capable of removing contaminants other than ions (e.g., free carbon filter, hollow membrane filter, and the like).

Referring to FIG. 20, the circulation pump 120 may pump water in the steam generation device 70 to the sump 105. The sump pump 115 may pump the water stored in the sump 105 to a branch flow path x0.

The branch flow path x0 may include a first flow path x1 configured to connect the sump 105 and the first filter 109a, and a second flow path x2 configured to connect the sump 105 and the second filter 109b.

The first flow path x1 may be configured to allow water supplied to the first flow path x1 to flow to the first filter 109a.

The second flow path x2 may be configured to allow water supplied to the second flow path x2 to flow to the second filter 109b. The second flow path x2 may be defined as a bypass flow path in that the second flow path x2 allows the water supplied to the second flow path x2 to bypass the first filter 109a and flow to the second filter 109b.

The steam generation system 100 according to an embodiment may include a first valve 130ac configured to open and close the first flow path x1 and a second valve 130ad configured to open and close the second flow path x2.

The valve 130ac configured to open and close the first flow path x1 and the valve 130ad configured to open and close the second flow path x2 may be implemented as a single valve (e.g., a three-way valve).

In an embodiment, in a case where the controller 250 operates the sump pump 115 to recover the condensate stored in the sump 105 to the water tank 80, the controller 250 may control the at least one valve 130 to close the first flow path x1 and open the second flow path x2. For example, because the condensate stored in the sump 105 is more likely to contain contaminated substances rather than ions, the clothes care apparatus 1 may close the first flow path x1, open the second flow path x2, and operate the sump pump 115 to recover the condensate stored in the sump 105, thereby allowing the condensate stored in the sump 105 to be recovered to the water tank 80 by passing through the second filter 109b. According to the disclosure, a life of the first filter 109a may be extended.

However, according to various embodiments, in a case where the controller 250 operates the sump pump 115 to recover the condensate stored in the sump 105 to the water tank 80, the controller 250 may also control the at least one valve 130 to open the first flow path x1 and close the second flow path x2.

In an embodiment, for the circulation process, the controller 250 may operate the circulation pump 120, the sump pump 115, and the water supply pump 110, and may control the at least one valve 130 to open one of the first flow path x1 or the second flow path x2 and close the other.

For example, for the circulation process, the controller 250 may operate the circulation pump 120, the sump pump 115, and the water supply pump 110, control the first valve 130ac to open the first flow path x1 and control the second valve 130ad to close the second flow path x2. As another example, for the circulation process, the controller 250 may operate the circulation pump 120, the sump pump 115, and the water supply pump 110, and may control the first valve 130ac to close the first flow path x1 and control the second valve 130ad to open the second flow path x2.

In a case where the circulation pump 120, the sump pump 115, and the water supply pump 110 operate while the first flow path x1 is closed and the second flow path x2 is open, the water in the steam generation device 70 may circulate by passing only through the second filter 109b without passing through the first filter 109a. The circulation process performed while the first flow path x1 is closed and the second flow path x2 is open may be defined as a bypass circulation process in that the water in the steam generation device 70 bypasses the first filter 109a. The circulation process performed while the first flow path x1 is closed and the second flow path x2 is open may also be defined as a non-ion filtering circulation process in that ions in the water in the steam generation device 70 are not filtered.

In a case where the circulation pump 120, the sump pump 115, and the water supply pump 110 operate while the first flow path x1 is open and the second flow path x2 is closed, the water in the steam generation device 70 may circulate by passing through both the first filter 109a and the second filter 109b. The circulation process performed while the first flow path x1 is open and the second flow path x2 is closed may be defined as a non-bypass circulation process in that the water in the steam generation device 70 passes through both the first filter 109a and the second filter 109b. The circulation process performed while the first flow path x1 is closed and the second flow path x2 is open may also be defined as an ion filtering circulation process in that ions in the water in the steam generation device 70 are filtered.

Referring to FIG. 21, the circulation pump 120 may include a first circulation pump 120a that pumps the water in the steam generation device 70 to a first flow path z1, and a second circulation pump 120b that pumps the water in the steam generation device 70 to a second flow path z2. The first circulation pump 120a may be the same pump as the sump pump 115.

The sump pump 115 may pump water stored in the sump 105 to the first flow path z1.

In addition, the sump pump 115 may pump water in the steam generation device 70 to the first flow path z1.

The first flow path z1 may be configured to allow water supplied to the first flow path z1 to flow to the first filter 109a.

The second flow path z2 may be configured to allow water supplied to the second flow path z2 to flow to the second filter 109b. The second flow path z2 may be defined as a bypass flow path in that the second flow path z2 allows the water supplied to the second flow path z2 to bypass the first filter 109a and flow to the second filter 109b.

The steam generation system 100 according to an embodiment may include a first valve 130j configured to open and close the first flow path z1 and a second valve 130h configured to open and close the second flow path z2. In addition, the steam generation system 100 according to an embodiment may further include a third valve 130i that opens and closes a third flow path z3 connecting the steam generation device 70 and the first circulation pump 120a.

In an embodiment, in a case where the controller 250 operates the sump pump 115 to recover the condensate stored in the sump 105 to the water tank 80, the controller 250 may control the at least one valve 130 to open the first flow path z1 and close the third flow path z3.

In an embodiment, in a case where the controller 250 controls the first valve 130j to open the first flow path z1, the controller 250 may control the second valve 130h to close the second flow path z2.

In an embodiment, in a case where the controller 250 controls the second valve 130h to open the second flow path z2, the controller 250 may control the first valve 130j to close the first flow path z1.

In an embodiment, the controller 250 may operate either the first circulation pump 120a or the second circulation pump 120b for a circulation process. Operating the first circulation pump 120a may include opening the third flow path z3 and the first flow path z1.

Operating the second circulation pump 120b may include opening the second flow path z2.

For example, for the circulation process, the controller 250 may operate the first circulation pump 120a and the water supply pump 110, control the first valve 130j to open the first flow path z1, control the second valve 130h to close the second flow path z2, and control the third valve 130i to open the third flow path z3. In this instance, an operation of controlling the second valve 130h to close the second flow path z2 may be omitted.

As another example, for the circulation process, the controller 250 may operate the second circulation pump 120b and the water supply pump 110, control the first valve 130j to close the first flow path z1, control the third valve 130i to close the third flow path z3, and control the second valve 130h to open the second flow path z2. In this instance, an operation of controlling the first valve 130j to close the first flow path z1 may be omitted.

In a case where the second circulation pump 120b and the water supply pump 110 operate, the water in the steam generation device 70 may circulate by passing only through the second filter 109b without passing through the first filter 109a. The circulation process performed by operating the second circulation pump 120b and the water supply pump 110 may be defined as a bypass circulation process in that the water in the steam generation device 70 bypasses the first filter 109a. The circulation process performed by operating the second circulation pump 120b and the water supply pump 110 may also be defined as a non-ion filtering circulation process in that ions in the water in the steam generation device 70 are not filtered.

In a case where the first circulation pump 120a and the water supply pump 110 operate, the water in the steam generation device 70 may circulate by passing through both the first filter 109a and the second filter 109b. The circulation process performed by operating the first circulation pump 120a and the water supply pump 110 may be defined as a non-bypass circulation process in that the water in the steam generation device 70 passes through both the first filter 109a and the second filter 109b. The circulation process performed by operating the first circulation pump 120a and the water supply pump 110 may also be defined as an ion filtering circulation process in that ions in the water in the steam generation device 70 are filtered.

According to the disclosure, as required, the water in the steam generation device 70 and/or the water stored in the sump 105 may be selectively allowed to bypass or pass through the first filter, and thus a life of the first filter may be improved.

FIG. 22 is a flowchart illustrating an example method for controlling a clothes care apparatus in a case where a bypass flow path is included in a steam generation system of the clothes care apparatus according to various embodiments.

FIG. 22 illustrates a method for controlling the clothes care apparatus 1 including the steam generation system 100 according to the embodiments shown in FIG. 19, FIG. 20, and FIG. 21.

Referring to FIG. 22, the clothes care apparatus 1 according to an embodiment may collect sensor data related to water in the steam generation device 70 (3100). A description of operation 3100 is omitted because the description overlaps with that of operation 1100 of FIG. 16.

The clothes care apparatus 1 may identify whether a contamination level of the water in the steam generation device 70 exceeds a preset contamination level (3200). A description of operation 3200 may not be repeated here because the description overlaps with that of operation 1200 of FIG. 16.

In an embodiment, the clothes care apparatus 1 may identify whether a cumulative storage time of the water in the steam generation device 70 has reached a preset time (3300). A description of operation 3300 may not be repeated here because the description overlaps with that of operation 1300 of FIG. 16.

In an embodiment, the clothes care apparatus 1 may perform a non-bypass circulation process (3400), based on the contamination level of the water in the steam generation device 70 being greater than or equal to the preset contamination level (Yes in operation 3200).

The controller 250 may control the steam generation system 100 to perform the non-bypass circulation process, based on the contamination level of the water in the steam generation device 70 being greater than or equal to the preset contamination level (Yes in operation 3200).

In an embodiment, the clothes care apparatus 1 may pump the water in the steam generation device 70 to allow the water in the steam generation device 70 to pass through the water purification filter 109 through the first flow path x1, y1, and z1 and flow into the water tank 80 in order to perform the non-bypass circulation process.

In the embodiment of FIG. 19, the controller 250 may operate the circulation pump 120, the sump pump 115, and the water supply pump 110 to perform the non-bypass circulation process. The circulation pump 120 may pump the water in the steam generation device 70 to the sump 105. The sump pump 115 may pump the water stored in the sump 105 to the branch flow path y0 including the first flow path y1 and the second flow path y2.

The controller 250 may control at least one valve 130aa and 130ab to open the first flow path y1 and close the second flow path y2. Accordingly, in the non-bypass circulation process, the water in the steam generation device 70 may pass through the water purification filter 109 and flow into the water tank 80.

In the embodiment of FIG. 20, the controller 250 may operate the circulation pump 120, the sump pump 115, and the water supply pump 110 to perform the non-bypass circulation process. The circulation pump 120 may pump the water in the steam generation device 70 to the sump 105. The sump pump 115 may pump the water stored in the sump 105 to the branch flow path x0 including the first flow path x1 and the second flow path x2.

The controller 250 may control at least one valve 130ac and 130ad to open the first flow path x1 and close the second flow path x2. Accordingly, in the non-bypass circulation process, the water in the steam generation device 70 may pass through both the first filter 109a and the second filter 109b and flow into the water tank 80.

In the embodiment of FIG. 21, the controller 250 may operate the first circulation pump 120a (=the sump pump 115) and the water supply pump 110 to perform the non-bypass circulation process. The first circulation pump 120a may supply the water in the steam generation device 70 to the first flow path z1 through the third flow path z3.

The controller 250 may control at least one valve 130h, 130i, and 130j to open the first flow path z1 and the third flow path z3 and close the second flow path z2. In this instance, the controller 250 may omit the operation of closing the second flow path z2.

Accordingly, in the non-bypass circulation process, the water in the steam generation device 70 may pass through both the first filter 109a and the second filter 109b and flow into the water tank 80.

According to the disclosure, in a case where the contamination level of the water in the steam generation device 70, e.g., the ion content of the water in the steam generation device 70, is high, by performing the non-bypass circulation process that allows the water in the steam generation device 70 to pass through the first filter 109a which is an ion removal filter, ions in the water in the steam generation device 70 may be efficiently removed.

In an embodiment, the clothes care apparatus 1 may perform a bypass circulation process (3500), based on the contamination level of the water in the steam generation device 70 being less than the preset contamination level (No in operation 3200) and the cumulative storage time of the water in the steam generation device 70 reaching the preset time (Yes in operation 3300).

The controller 250 may control the steam generation system 100 to perform the bypass circulation process, based on the contamination level of the water in the steam generation device 70 being less than the preset contamination level (No in operation 3200) and the cumulative storage time of the water in the steam generation device 70 reaching the preset time (Yes in operation 3300).

In an embodiment, the clothes care apparatus 1 may pump the water in the steam generation device 70 to allow the water in the steam generation device 70 to bypass the water purification filter 109 through the second flow path x2, y2, and z2, or to pass only through the second filter 109b among the first filter 109a and the second filter 109b and then flow into the water tank 80 in order to perform the bypass circulation process.

In the embodiment of FIG. 19, the controller 250 may operate the circulation pump 120, the sump pump 115, and the water supply pump 110 to perform the bypass circulation process. The circulation pump 120 may pump the water in the steam generation device 70 to the sump 105. The sump pump 115 may pump the water stored in the sump 105 to the branch flow path y0 including the first flow path y1 and the second flow path y2.

The controller 250 may control at least one valve 130aa and 130ab to close the first flow path y1 and open the second flow path y2. Accordingly, in the bypass circulation process, the water in the steam generation device 70 may bypass the water purification filter 109 and flow into the water tank 80.

In the embodiment of FIG. 20, the controller 250 may operate the circulation pump 120, the sump pump 115, and the water supply pump 110 to perform the bypass circulation process. The circulation pump 120 may pump the water in the steam generation device 70 to the sump 105. The sump pump 115 may pump the water stored in the sump 105 to the branch flow path x0 including the first flow path x1 and the second flow path x2.

The controller 250 may control at least one valve 130ac and 130ad to close the first flow path x1 and open the second flow path x2. Accordingly, in the bypass circulation process, the water in the steam generation device 70 may pass only through the second filter 109b and flow into the water tank 80.

In the embodiment of FIG. 21, the controller 250 may operate the second circulation pump 120b and the water supply pump 110 to perform the bypass circulation process. The second circulation pump 120b may supply the water in the steam generation device 70 to the second flow path z3.

The controller 250 may control at least one valve 130h, 130i, and 130j to close the first flow path z1 and the third flow path z3 and open the second flow path z2. In this instance, the controller 250 may omit the operation of closing the first flow path z1.

Accordingly, in the bypass circulation process, the water in the steam generation device 70 may pass only through the second filter 109b and flow into the water tank 80.

According to the disclosure, in a case where the contamination level of the water in the steam generation device 70, e.g., the ion content of the water in the steam generation device 70, is low, by performing the bypass circulation process that prevents and/or reduces the water in the steam generation device 70 from passing through the first filter 109a which is an ion removal filter, a life expectancy of the first filter 109a may be improved.

In addition, according to the disclosure, in a case where the water in the steam generation device 70 has been accumulated for a long time, the water may be kept clean in the water tank 80 and/or the steam generation device 70 by circulating the water without passing through the water purification filter 109 or by passing only through the second filter to remove suspended substances.

According to the disclosure, the steam generation system 100 in which a user is not required to fill/recover water may be provided.

Further, the steam generation system 100 according to disclosed embodiments may include a sterilization device 160 for sterilizing water stored in the water tank 80.

Sterilizing the water stored in the water tank 80 may include irradiating the interior of the water tank 80 with ultraviolet light.

However, when irradiating the interior of the water tank 80 with ultraviolet light, the higher the water level in the water tank 80, the less efficient the sterilization may be.

According to one embodiment, sterilizing water stored in the water tank 80 may include irradiating water flowing in a separate flow path connected to the water tank 80 with ultraviolet light.

Accordingly, the sterilization device 160 may be referred to as a flow-through sterilizer.

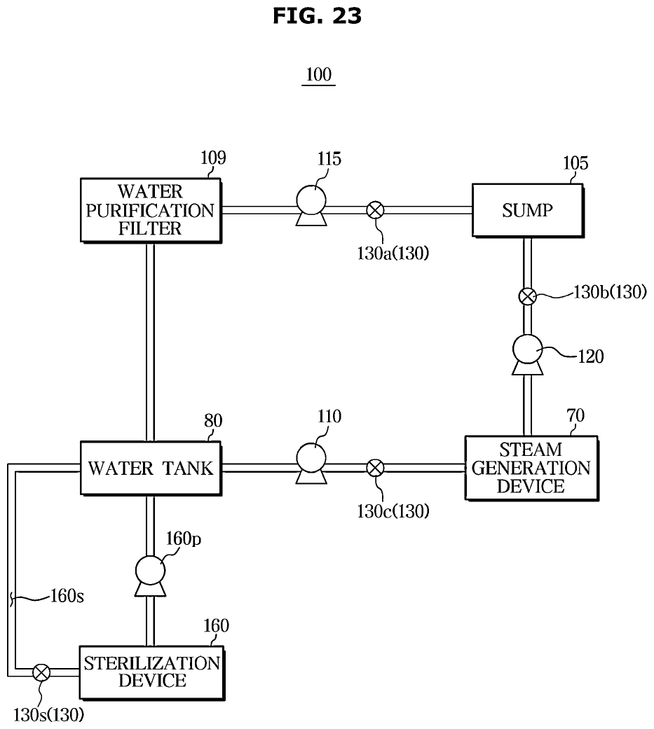

FIG. 23 is a diagram illustrating one example of a steam generation system including a sterilization device according to various embodiments.

Referring to FIG. 23, the steam generation system 100 according to one embodiment may include a sterilization pump 160p that pumps water stored in the water tank 80 into the sterilization flow path 160s, a sterilization device 160 that irradiates the water flowing through the sterilization flow path 160s with ultraviolet light, and/or a valve 130s that opens and closes the sterilization flow path 160s. However, depending on the embodiment, the valve 130s may be omitted.

In one embodiment, an operation of pumping water stored in the water tank 80 into the sterilization flow path 160s and operating the sterilization device 160 may be defined as a sterilization operation.

Activating the sterilization device 160 may include turning on the UV lamp, and stopping the sterilization device 160 may include turning off the UV lamp.

The controller 250 may perform the sterilization operation by operating the sterilization pump 160p and the sterilization device 160. The controller 250 may control the valve 130s to open the sterilization flow path 160s during the sterilization operation.

The controller 250 may terminate the sterilization process by stopping the sterilization pump 160p and the sterilization device 160. The controller 250 may control the valve 130s to close the sterilization flow path 160s when no the sterilization operation is performed.

As previously described, water stored in the sump 105 may be provided to the water tank 80 through the water purification filter 109. The water stored in the water tank 80 may be sterilized and returned to the water tank 80 via the sterilization flow path 160s. In this case, the water stored in the water tank 80 may be efficiently sterilized.

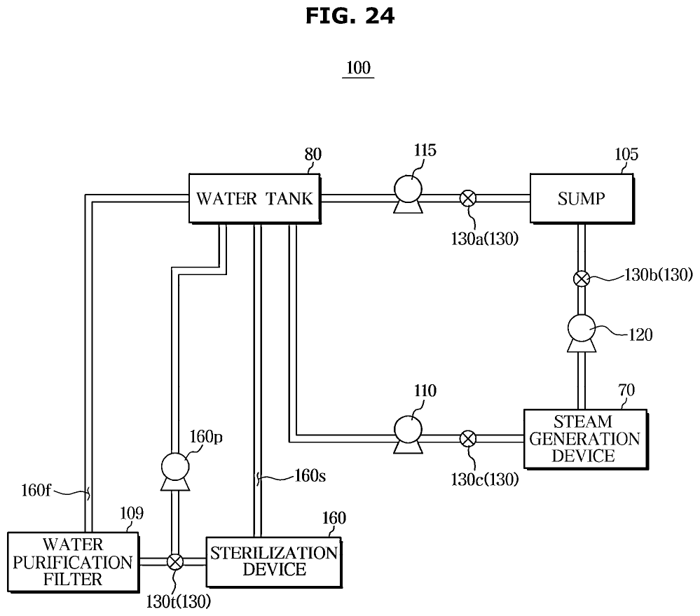

FIG. 24 is a diagram illustrating another example of a steam generation system including a sterilization device according to various embodiments.

Referring to FIG. 24, the steam generation system 100 according to one embodiment may include a sterilization pump 160p that pumps water stored in the water tank 80 into the sterilization flow path 160s or the purification flow path 160f, a sterilization device 160 that irradiates the water flowing through the sterilization flow path 160s with ultraviolet light, and/or a valve 130t that opens and closes the sterilization flow path 160s or the purification flow path 160f.

The valve 130t may be a three-way valve for selectively connecting water stored in the water tank 80 with either the sterilization flow path 160s or the purification flow path 160f.

The purification flow path 160f may refer to a flow path connected to the water purification filter 109.

The valve 130t may selectively connect a flow path through which water stored in the water tank 80 flows with the sterilization flow path 160s or the purification flow path 160f.

In one embodiment, an operation of pumping the water stored in the water tank 80 to the purification flow path 160f may be defined as a filtering operation, and an operation of pumping the water stored in the water tank 80 to the sterilization flow path 160s and operating the sterilization device 160 may be defined as a sterilization operation.

The filtering operation may refer to the operation of connecting a flow path through which the water stored in the water tank 80 flows with the water purification path 160f and operating the sterilization pump 160p, and the sterilization operation may refer to the operation of connecting the flow path through which the water stored in the water tank 80 flows with the sterilization fluid path 160s and operating the sterilization pump 160p and the sterilization device 160.

The controller 250 may perform the filtering operation and/or the sterilization operation by controlling the sterilization pump 160p, the valve 130t, and the sterilization device 160.

The controller 250 may perform the filtering operation for a first predetermined time and then perform the sterilization operation for a second predetermined time. Here, the first predetermined time may be shorter than the second predetermined time.

For example, the controller 250 may control the valve 130t to connect t the flow path through which the water stored in the water tank 80 flows with the water purification flow path 160f and operate the sterilization pump 160p, and may control the valve 130t to connect the flow path through which the water stored in the water tank 80 flows with the sterilization flow path 160s and operate the sterilization device 160 when the first predetermined time elapses, and may stop the sterilization pump 160p and the sterilization device 160 when the second predetermined time elapses.

According to one embodiment, the water stored in the sump 105 may be stored in the water tank 80 first, rather than immediately passing through the water purification filter 109, before proceeding with the filtering and sterilization.

According to the present invention, by first storing the water stored in the sump 105 in the water tank 80 before proceeding with the filtering and sanitizing process, there is less risk of air entering the water purification filter 109.

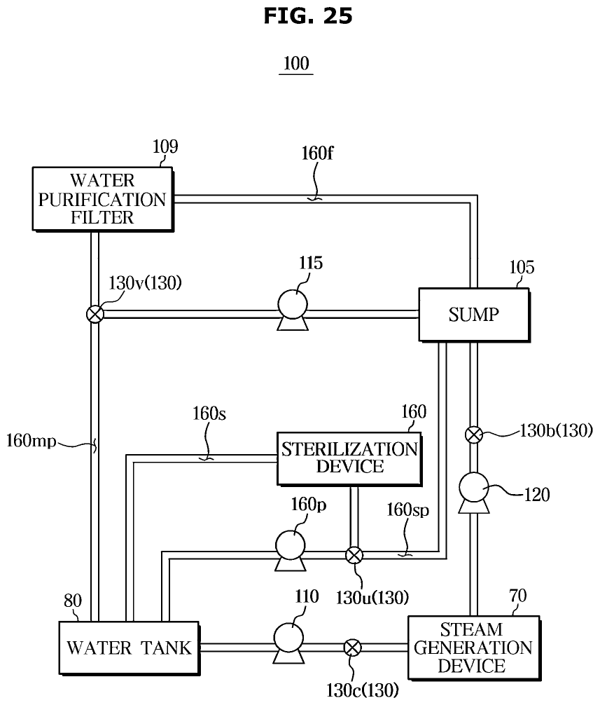

FIG. 25 is a diagram illustrating the other example of a steam generation system including a sterilization device according to various embodiments.

Referring to FIG. 25, the steam generation system 100 according to one embodiment includes a sterilization pump 160p that pumps water stored in the water tank 80 into a sterilization flow path 160s or a flow path 160sp connected to the sump 105, and a sterilization device 160 that irradiates the water flowing through the sterilization flow path 160s with ultraviolet light, a valve 130u for opening and closing the sterilization flow path 160s and/or the flow path 160sp connected to the sump 105, a sump pump 115 for pumping water stored in the sump 105, and a valve 130v for opening and closing the purification flow path 160f and/or the water tank flow path 160mp.

The water tank flow path 160mp is a flow path connected to the water tank 80, through which water pumped by the sump pump 115 can flow.

Valve 130u may be a three-way flow path for selectively connecting water stored in water tank 80 with either sterilization flow path 160s or sump flow path 160sp.

The valve 130v may be a three-way flow path for selectively connecting water stored in the sump 105 with either the purification flow path 160f or the water tank flow path 160mp.

In one embodiment, an operation of pumping water stored in the sump 105 to the water purification flow path 160f may be defined as a filtering operation, and an operation of pumping water stored in the water tank 80 to the sterilization flow path 160s and operating the sterilization device 160 may be defined as a sterilization operation.

The filtering operation may be defined as an operation of connecting a flow path through which water stored in the sump 105 flows with the water purification path 160f and operating the sump pump 115, and the sterilization operation may be defined as an operation of connecting a flow path through which water stored in the water tank 80 flows with the sterilization flow path 160s and operating the sterilization pump 160p and the sterilization device 160.

The controller 250 may perform the filtering operation and/or the sterilization operation by controlling the sump pump 115, the sterilization pump 160p, the valves 130u, 130v, and the sterilization device 160.

The controller 250 may control the valve 130u to open the sump flow path 160sp and close the sterilization flow path 160s, and may operate the sterilization pump 160p to draw water stored in the water tank 80 into the sump 105.

The controller 250 may perform the filtering operation by controlling the valve 130v to open the water purification flow path 160f and close the water tank flow path 160mp, and by operating the sump pump 115. In the filtering operation, the water stored in the sump 105 may be filtered through the water purification filter 109.

After the filtering operation, the controller 250 may control the valve 130v to close the water purification path 160f and open the water tank path 160mp and operate the sump pump 115 to draw the water filtered by the filtering operation and stored in the sump 105 into the water tank 80.

The controller 250 may perform the sterilization operation by controlling the valve 130u to open the sterilization flow path 160s and close the sump flow path 160sp, and operating the sterilization pump 160p. During the sterilization operation, the water stored in the water tank 80 may flow into the sterilization flow path 160s, and the water flowing through the sterilization flow path 160s may be sterilized by receiving ultraviolet light from the sterilization device 160 and then flow back into the water tank 80.

According to the present invention, contamination of the water tank 80 can be prevented by introducing water filtered by the water filter 109 into the water tank 80, and the problem of air entering the water filter 109 can be solved by circulating the water stored in the sump 105 during the filtering operation, and the problem of hygiene of the water tank 80 can be solved by sterilizing the water at the water tank 80 side alone only when a sterilization operation is required.

The controller 250 may perform the sterilization operation based on a predetermined condition being satisfied.

In one embodiment, the controller 250 may perform the sterilization operation based on the clothes care process (e.g., steam process or dehumidification process) or a clothes care course being finished.

For example, the controller 250 may perform the sterilization operation in response to a predetermined amount of time having elapsed since the end of the clothes care process (e.g., steam process or dehumidification process) or the end of the clothes care course.

In the embodiment of FIG. 23, the controller 250 may operate the sump pump 115 for a predetermined period of time based on the clothes care process (e.g., steam process or dehumidification process) or the clothes care course being finished to cause water stored in the sump 105 to flow through the water filter 109 and into the water tank 80. When the operation of the sump pump 115 ends, the controller 250 can operate the sterilization pump 160p and the sterilization device 160 to cause the water stored in the water tank 80 to be sterilized by the sterilization device 160 and then returned to the water tank 80.

In the embodiment of FIG. 24, the controller 250 may operate the sump pump 115 for a predetermined amount of time based on the clothes care process (e.g., steam process or dehumidification process) or the clothes care course being finished to cause the water stored in the sump 105 to flow into the water tank 80.

After operating the sump pump 115 for the predetermined period of time, the controller 250 may perform the filtering operation to cause the water stored in the water tank 80 to pass through the water filter 109 and be returned to the water tank 80. When the filtering operation ends, the controller 250 may perform the sterilization operation to cause the water stored in the water tank 80 to be sterilized by the sterilization device 160 and returned to the water tank 80.

In the embodiment of FIG. 25, the controller 250 may control the valve 130v to open the water purification flow path 160f based on the clothes care process (e.g., steam process or dehumidification process) or the clothes care course being finished, and may operate the sump pump 115 to perform the filtering operation to cause the water stored in the sump 105 to pass through the water filter 109 and be returned to the sump 105. The controller 250 may control the valve 130v to open the water tank flow path 160mp at the end of the filtering operation and operate the sump pump 115 for a predetermined period of time to allow the water stored in the sump 105 to flow into the water tank 80. The controller 250 may operate the sump pump 115 for a predetermined period of time and then perform the sterilization operation to ensure that the water stored in the water tank 80 is sterilized by the sterilization device 160 and returned to the water tank 80.

In one embodiment, the controller 250 may perform the sterilization operation based on an going out mode being set.

The going out mode may be set by a user via the user interface device 200. The user interface device 200 may include an input device (e.g., a button) for setting the going out mode.

The going out mode may be set based on control commands received from the server device and/or the user device via the communication circuitry 300.

According to the present invention, the water stored in the water tank 80 can be sterilized by flowing water method to efficiently prevent microorganisms from growing in the water tank 80.

Meanwhile, the disclosure is also applicable to other appliances (or electronic devices) other than the clothes care apparatus 1. In other words, the disclosed embodiments may be applied to a variety of appliances that may include the steam generation system 100.

According to various embodiments, a variety of appliances, such as a washing machine, dryer, shoe care apparatus, cooking appliance (e.g., steam oven), dishwasher, cleaner, steam iron, air conditioner, and/or humidifier, may include the steam generation system 100 and the controller 250 for controlling the steam generation system 100 according to an embodiment. According to various embodiments, various appliances, such as a washing machine, dryer, shoe care apparatus, cooking appliance (e.g., steam oven), dishwasher, cleaner, steam iron, air conditioner, and/or humidifier, may not include some components (e.g., sump 105) of the steam generation system 100 according to an embodiment.

A variety of appliances, such as a washing machine, dryer, shoe care apparatus, cooking appliance (e.g., steam oven), dishwasher, cleaner, steam iron, air conditioner, steam sterilizer, steam hairstyling device, and/or humidifier, may control the steam generation system 100 to perform a circulation process based on a preset condition being satisfied.

The washing machine according to an embodiment may include the steam generation system 100 and the controller 250, and may use steam for washing a garment to improve a washing effectiveness.

The dryer according to an embodiment may include the steam generation system 100 and the controller 250, and may use steam for drying a garment to sterilize an object to be dried.

The shoe care apparatus according to an embodiment may include the steam generation system 100 and the controller 250, and may use steam for drying shoes to sterilize the shoes.

The steam oven according to an embodiment may include the steam generation system 100 and the controller 250, and may use steam for cooking food to maintain moisture in the food.

The dishwasher according to an embodiment may include the steam generation system 100 and the controller 250, and may use steam to efficiently remove residues left on dishes.

The cleaner according to an embodiment may include the steam generation system 100 and the controller 250, and may use steam to efficiently clean an area to be cleaned.

The steam iron according to an embodiment may include the steam generation system 100 and the controller 250, and may use steam to improve ironing performance.

The air conditioner according to an embodiment may include the steam generation system 100 and the controller 250, and may use steam to adjust humidity and improve air quality.

The steam sterilizer according to an embodiment may include the steam generation system 100 and the controller 250, and may spray steam to an object to be sterilized to sterilize the object to be sterilized.

The steam hairstyling device according to an embodiment may include the steam generation system 100 and the controller 250, and may spray steam to a user's hair to assist in styling the user's hair.

The humidifier according to an embodiment may include the steam generation system 100 and the controller 250, and may use steam to adjust humidity and improve air quality.

According to an example embodiment of the disclosure, the clothes care apparatus may include: a main body; a chamber formed in the main body; a heat exchanger configured to dehumidify air in the chamber; a water purification filter; a water tank disposed downstream of the water purification filter; a steam generation device comprising a steam generator including a case and configured to generate steam using water supplied from the water tank and spray the generated steam into the chamber; a sump configured to store at least one of condensate discharged from the heat exchanger and/or condensate discharged from the steam generation device; a water supply pump configured to pump water stored in the water tank to the steam generation device; a sump pump configured to pump water stored in the sump to the water purification filter; a circulation pump configured to pump water in the steam generation device to the sump and/or the water purification filter; and a controller comprising at least one processor, comprising processing circuitry, individually and/or collectively, configured to operate the circulation pump based on a specified condition being satisfied.

The specified condition may include a contamination level of the water in the steam generation device being greater than or equal to a specified contamination level.

The specified condition may include a cumulative storage time of the water in the steam generation device reaching a specified time.

The clothes care apparatus may further include a sterilization pump configured to pump the water stored in the water tank to a sterilization flow path; and a sterilization device configured to irradiate ultraviolet light to water flowing through the sterilization flow path, wherein the at least one processor of the controller, individually and/or collectively may be further configured to operate the sterilization pump and the sterilization device after operating the sump pump to pump the water stored in the sump to the water purification filter such that the water stored in the water tank is sterilized in the sterilization flow path and then retrieved to the water tank.

The clothes care apparatus may further include an electrolysis device including circuitry configured to electrolyze the water in the steam generation device, wherein at least one processor of the controller, individually and/or collectively may be configured to operate the electrolysis device based on the specified condition being satisfied.

The clothes care apparatus may further include: a deionization module comprising a filter and/or a capacitive circuit; and a deionization pump configured to pump the water in the steam generation device to allow the water in the steam generation device to flow back into the steam generation device after passing through the deionization module, wherein at least one processor of the controller, individually and/or collectively, may be configured to operate the deionization pump for a specified time in response to the specified condition being satisfied, and operate the circulation pump based on an operation of the deionization pump being stopped.

The circulation pump may be configured to pump the water in the steam generation device to the sump, and at least one processor of the controller, individually and/or collectively, may be configured to operate the circulation pump and the sump pump together based on the specified condition being satisfied.

The sump pump may be configured to pump the water stored in the sump to a branch flow path, the branch flow path may include: a first flow path configured to allow the water supplied to the branch flow path to flow to the water purification filter; and a second flow path configured to allow the water supplied to the branch flow path to flow to the water tank, and the clothes care apparatus may include at least one valve configured to open and close the first flow path and the second flow path.

At least one processor of the controller, individually and/or collectively, may be configured to control the at least one valve to close the first flow path and open the second flow path, based on a contamination level of the water in the steam generation device being less than a specified contamination level and a cumulative storage time of the water in the steam generation device reaching a specified time.

At least one processor of the controller, individually and/or collectively, may be configured to control the at least one valve to open the first flow path and close the second flow path, based on a contamination level of the water in the steam generation device being greater than or equal to a specified contamination level.

The water purification filter may include: a first filter; and a second filter disposed downstream of the first filter, the water tank may be disposed downstream of the second filter, the sump pump may be configured to pump the water stored in the sump to a branch flow path, the branch flow path may include: a first flow path configured to allow the water supplied to the branch flow path to flow to the first filter; and a second flow path configured to allow the water supplied to the branch flow path to flow to the second filter, and the clothes care apparatus may include at least one valve configured to open and close the first flow path and the second flow path.

The water purification filter may include: a first filter; and a second filter disposed downstream of the first filter, the water tank may be disposed downstream of the second filter, the sump pump may be configured to pump the water in the steam generation device to a first flow path, the circulation pump may be configured to pump the water in the steam generation device to a second flow path, the first flow path may be configured to allow the water supplied to the first flow path to flow to the first filter; and the second flow path may be configured to allow the water supplied to the second flow path to flow to the second filter, and the clothes care apparatus may include at least one valve 30 configured to open and close the first flow path and the second flow path.

At least one processor of the controller, individually and/or collectively, may be configured to control the at least one valve to close the first flow path and open the second flow path, based on a contamination level of the water in the steam generation device being less than a specified contamination level and a cumulative storage time of the water in the steam generation device reaching a specified time.

At least one processor of the controller, individually and/or collectively, may be configured to control the at least one valve to open the first flow path and close the second flow path, based on a contamination level of the water in the steam generation device being greater than or equal to a specified contamination level.

The water in the steam generation device may flow to the water purification filter through the first flow path based on an operation of the circulation pump, and the water stored in the sump may flow to the water purification filter through the second flow path based on an operation of the sump pump, and the clothes care apparatus may include at least one valve configured to open and close the first flow path and the second flow path.

According to an example embodiment of the disclosure, in a method for controlling a clothes care apparatus including a water purification filter, a water tank disposed downstream of the water purification filter, a steam generation device comprising a steam generator including a case and configured to generate steam using water supplied from the water tank and spray the generated steam to a chamber, and a sump configured to store at least one of condensate discharged from a heat exchanger configured to dehumidify air in the chamber or condensate discharged from the steam generation device, the method may include: pumping water in the steam generation device to the sump or the water purification filter, based on a specified condition being satisfied.

The specified condition may include at least one of a contamination level of the water in the steam generation device being greater than or equal to a specified contamination level, or a cumulative storage time of the water in the steam generation device reaching a specified time.

The method may further include operating an electrolysis device configured to electrolyze the water in the steam generation device based on the specified condition being satisfied.

The pumping of the water in the steam generation device to the sump or the water purification filter may include pumping the water in the steam generation device to the sump. The method may further include: pumping the water stored in the sump to a branch flow path that includes a first flow path connected to the water purification filter and a second flow path connected to the water tank; and closing the first flow path and opening the second flow path based on a contamination level of the water in the steam generation device being less than a specified contamination level and a cumulative storage time of the water in the steam generation device reaching a specified time.

The water purification filter may include: a first filter; and a second filter disposed downstream of the first filter, and the pumping of the water in the steam generation device to the sump or the water purification filter may include pumping the water in the steam generation device to the sump. The method may further include: pumping the water stored in the sump to a branch flow path that includes a first flow path connected to the first filter and a second flow path connected to the second filter; and closing the first flow path and opening the second flow path based on a contamination level of the water in the steam generation device being less than a specified contamination level and a cumulative storage time of the water in the steam generation device reaching a specified time.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory storage medium, wherein the ‘non-transitory storage medium’ is a storage medium that is a tangible device, and may not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment, the method according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skill in the art will appreciate that other specific modifications may be easily made without departing from the technical spirit or essential features 10 of the disclosure. Therefore, the foregoing embodiments should be regarded as illustrative rather than limiting in all aspects. It will also be understood that any of the embodiment(s) described herein may be used in conjunction with any other embodiment(s) described herein.

What is claimed is:

1. A clothes care apparatus, comprising:
a main body;
a chamber formed in the main body;
a heat exchanger configured to dehumidify air in the chamber;
a water purification filter;
a water tank disposed downstream of the water purification filter;
a steam generation device configured to generate steam using water supplied from the water tank and spray the generated steam into the chamber;
a sump configured to store at least one of condensate discharged from the heat exchanger and/or condensate discharged from the steam generation device;
a water supply pump configured to pump water stored in the water tank to the steam generation device;
a sump pump configured to pump water stored in the sump to the water purification filter;
a circulation pump configured to pump water in the steam generation device to the sump or the water purification filter; and
a controller comprising at least one processor, comprising processing circuitry, individually and/or collectively, configured to operate the circulation pump based on a specified condition being satisfied.

2. The clothes care apparatus of claim 1, wherein the specified condition includes at least one of: a contamination level of the water in the steam generation device being greater than or equal to a specified contamination level or a cumulative storage time of the water in the steam generation device reaching a specified time.

3. The clothes care apparatus of claim 1, further comprising:
a sterilization pump configured to pump the water stored in the water tank to a sterilization flow path; and
a sterilization device configured to irradiate ultraviolet light to water flowing through the sterilization flow path,
wherein at least one processor of the controller, individually and/or collectively, is further configured to operate the sterilization pump and the sterilization device after operating the sump pump to pump the water stored in the sump to the water purification filter such that the water stored in the water tank is sterilized in the sterilization flow path and then retrieved to the water tank.

4. The clothes care apparatus of claim 1, further comprising:
an electrolysis device configured to electrolyze the water in the steam generation device,
wherein at least one processor of the controller, individually and/or collectively, is configured to operate the electrolysis device based on the specified condition being satisfied.

5. The clothes care apparatus of claim 1, further comprising:
a deionization module comprising a filter and/or a capacitive circuit; and
a deionization pump configured to pump the water in the steam generation device to allow the water in the steam generation device to flow back into the steam generation device after passing through the deionization module,
wherein at least one processor of the controller, individually and/or collectively, is configured to operate the deionization pump for a specified time in response to the specified condition being satisfied, and operate the circulation pump based on an operation of the deionization pump being stopped.

6. The clothes care apparatus of claim 1, wherein the circulation pump is configured to pump the water in the steam generation device to the sump, and
at least one processor of the controller, individually and/or collectively, is configured to operate the circulation pump and the sump pump together based on the specified condition being satisfied.

7. The clothes care apparatus of claim 1, wherein the sump pump is configured to pump the water stored in the sump to a branch flow path,
wherein the branch flow path comprises:
a first flow path configured to allow the water supplied to the branch flow path to flow to the water purification filter; and
a second flow path configured to allow the water supplied to the branch flow path to flow to the water tank, and
the clothes care apparatus comprises at least one valve configured to open and close the first flow path and the second flow path.

8. The clothes care apparatus of claim 7, wherein at least one processor of the controller, individually and/or collectively, is configured to control the at least one valve to close the first flow path and open the second flow path, based on a contamination level of the water in the steam generation device being less than a specified contamination level and a cumulative storage time of the water in the steam generation device reaching a specified time.

9. The clothes care apparatus of claim 7, wherein at least one processor of the controller, individually and/or collectively, is configured to control the at least one valve to open the first flow path and close the second flow path, based on a contamination level of the water in the steam generation device being greater than or equal to a specified contamination level.

10. The clothes care apparatus of claim 1, wherein the water purification filter comprises:
a first filter; and
a second filter disposed downstream of the first filter,
wherein the water tank is disposed downstream of the second filter,
the sump pump is configured to pump the water stored in the sump to a branch flow path,
wherein the branch flow path comprises:
a first flow path configured to allow the water supplied to the branch flow path to flow to the first filter; and
a second flow path configured to allow the water supplied to the branch flow path to flow to the second filter, and
the clothes care apparatus comprises at least one valve configured to open and close the first flow path and the second flow path.

11. The clothes care apparatus of claim 1, wherein the water purification filter comprises:
a first filter; and
a second filter disposed downstream of the first filter,
wherein the water tank is disposed downstream of the second filter,
the sump pump is configured to pump the water in the steam generation device to a first flow path,
the circulation pump is configured to pump the water in the steam generation device to a second flow path,
the first flow path is configured to allow the water supplied to the first flow path to flow to the first filter; and
the second flow path is configured to allow the water supplied to the second flow path to flow to the second filter, and
the clothes care apparatus comprises at least one valve configured to open and close the first flow path and the second flow path.

12. The clothes care apparatus of claim 10, wherein at least one processor of the controller, individually and/or collectively, is configured to control the at least one valve to close the first flow path and open the second flow path, based on a contamination level of the water in the steam generation device being less than a specified contamination level and a cumulative storage time of the water in the steam generation device reaching a specified time.

13. The clothes care apparatus of claim 10, wherein at least one processor of the controller, individually and/or collectively, is configured to control the at least one valve to open the first flow path and close the second flow path, based on a contamination level of the water in the steam generation device being greater than or equal to a specified contamination level.

14. The clothes care apparatus of claim 1, wherein the water in the steam generation device flows to the water purification filter through the first flow path based on an operation of the circulation pump, and the water stored in the sump flows to the water purification filter through the second flow path based on an operation of the sump pump, and
the clothes care apparatus comprises at least one valve configured to open and close the first flow path and the second flow path.

15. A method for controlling a clothes care apparatus comprising a water purification filter, a water tank disposed downstream of the water purification filter, a steam generation device configured to generate steam using water supplied from the water tank and spray the generated steam to a chamber, and a sump configured to store at least one of condensate discharged from a heat exchanger configured to dehumidify air in the chamber or condensate discharged from the steam generation device, the method comprising:
pumping water in the steam generation device to the sump or the water purification filter, based on a specified condition being satisfied.

16. The method of claim 15, wherein specified condition may include at least one of a contamination level of the water in the steam generation device being greater than or equal to a specified contamination level, or a cumulative storage time of the water in the steam generation device reaching a specified time.

17. The method of claim 15, further comprising operating an electrolysis device configured to electrolyze the water in the steam generation device based on the specified condition being satisfied.

18. The method of claim 15, wherein the pumping water in the steam generation device to the sump or the water purification filter, based on the specified condition being satisfied comprises pumping the water in the steam generation device to the sump, and
wherein the method further comprises:
pumping the water stored in the sump to a branch flow path that includes a first flow path connected to the water purification filter and a second flow path connected to the water tank; and closing the first flow path; and
opening the second flow path based on a contamination level of the water in the steam generation device being less than a specified contamination level and a cumulative storage time of the water in the steam generation device reaching a specified time.

19. The method of claim 15, wherein the water purification filter comprises a first filter and a second filter disposed downstream of the first filter, wherein the pumping of the water in the steam generation device to the sump or the water purification filter comprises pumping the water in the steam generation device to the sump.

20. The method of claim 19, wherein the method further comprises pumping the water stored in the sump to a branch flow path that includes a first flow path connected to the first filter and a second flow path connected to the second filter; and closing the first flow path and opening the second flow path based on a contamination level of the water in the steam generation device being less than a specified contamination level and a cumulative storage time of the water in the steam generation device reaching a specified time.
